(19) United States
(12) Patent Application Publication
(10) Pub. No.: US 2019/0238360 A1
(43) Pub. Date: Aug. 1, 2019

(54) SMART DEVICES FOR HOUSEHOLD CONSUMABLES

(71) Applicant: Target Brands, Inc., Minneapolis, MN (US)

(72) Inventors: Adam M. Laskowitz, San Francisco, CA (US); Yeshwanth M. Gowda, Walnut Creek, CA (US); Edwardo Martinez, Fremont, CA (US); Mingjing Huang, San Francisco, CA (US); Bashir Ziady, San Francisco, CA (US); Mark Biasotti, San Jose, CA (US); Torence Lu, Fremont, CA (US); Niall Macken, Santa Cruz, CA (US); Joe Watson, San Jose, CA (US); Jacob Sandoval, San Jose, CA (US); Lim Hsu, San Jose, CA (US); Dan Wilkins, San Jose, CA (US); Ross Thayer, San Jose, CA (US); Arne Lang-Ree, Los Gatos, CA (US); Daniel deLaveaga, Reno, NV (US); Joe Fitzpatrick, Reno, NV (US); Eric Goodman, Ventura, CA (US); Ryan Oddo, Sparks, NV (US)

(21) Appl. No.: 16/263,407

(22) Filed: Jan. 31, 2019

Related U.S. Application Data
(60) Provisional application No. 62/624,203, filed on Jan. 31, 2018.
(60) Provisional application No. 62/702,978, filed on Jul. 25, 2018.

(51) Int. Cl. H04L 12/28; G06K 19/07; G01G 19/64; H04W 4/38; G01P 1/12

(52) U.S. Cl. CPC H04L 12/2827; G06K 19/0716; G01P 1/12; H04W 4/38; G01G 19/64

(57) ABSTRACT

A smart device for a household consumable includes at least one load sensor configured to measure a current load of a household consumable being supported by the smart device and a processor configured to compare the current load to a previously measured load to determine whether to increment one of a plurality of consumption event counters. The processor is configured to periodically transmit data located in the plurality of consumption event counters.

### CROSS-REFERENCE TO RELATED APPLICATION

The present application is based on and claims the benefit of U.S. provisional patent application Ser. No. 62/624,203, filed Jan. 31, 2018, and U.S. provisional patent application Ser. No. 62/702,978, filed Jul. 25, 2018 the contents of which are hereby incorporated by reference in their entireties.

### BACKGROUND

The Internet of Things (IoT) is a network of physical devices or objects called smart devices that are embedded with electronics, software, sensors and network connectivity for enabling the objects or smart devices to connect and exchange data, for example consumption data. The IoT allows these objects or smart devices to be sensed or controlled remotely across the network so as to integrate the physical world into computer-based systems. Oftentimes, smart devices use or dispense consumables, which need to be replenished over time. In particular, smart home devices consume or dispense household consumables that need to be replenished periodically.

The discussion above is merely provided for general background information and is not intended to be used as an aid in determining the scope of the claimed subject matter.

### SUMMARY

A smart device for a household consumable includes at least one load sensor configured to measure a current load of a household consumable being supported by the smart device and a processor configured to compare the current load to a previously measured load to determine whether to increment one of a plurality of consumption event counters. The processor is configured to periodically transmit data located in the plurality of consumption event counters.

A smart device for a household consumable includes a spindle configured for insertion into a holder and configured to support a roll of household consumable. The smart device further includes an accelerometer and a processor located in the spindle. The accelerometer is configured to sense acceleration including current Z-axis direction and current magnitude. The processor is configured to compare the current Z-axis direction with a previous Z-axis to determine whether to increment one of a plurality of consumption event counters and is configured to compare the current magnitude with a previous magnitude to determine whether to increment a different one of the plurality of consumption event counters. The processor periodically transmits data located in the plurality of consumption event counters.

A smart device for dispensing a household consumable includes a base that houses a plurality of internal components including at least one load sensor, a processor and a platform. The at least one load sensor is coupled to the platform. A body is coupled to the base and includes an internal bag made of a flexible material. The internal bag holds a liquid. A pump is configured to pump liquid out of the internal bag and through a spout connected to the pump. The internal bag engages with the platform and is weighed by the at least one load sensor. The processor is configured to compare a weight of the internal bag and its liquid contents to a previously measured weight of the internal bag and its liquid contents to determine if a consumption event has occurred.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a perspective view of a smart device for dispensing a household consumable according to an embodiment.

FIG. 2 is an exploded perspective view of the smart device of FIG. 1.

FIG. 3 is a section view of the smart device of FIG. 1.

FIG. 4 is an enlarged view of a portion of the section view of FIG. 3.

FIG. 5 is a flow chart of a method of tracking consumption events of a consumable being dispensed by the smart device illustrated in FIGS. 1-4 according to an embodiment.

FIG. 6 is a flow chart of a method of reporting consumption events to an auto replenishment service or system.

FIG. 7 is a perspective view of a smart device where the smart device supports a dispenser for a household consumable according to an embodiment.

FIG. 8 is a top perspective view of the smart device of FIG. 7 without the dispenser.

FIG. 9 is a bottom perspective view of the smart device of FIG. 7.

FIG. 10 is a perspective sectional view of the smart device of FIG. 7.

FIG. 11 is an exploded perspective view of the smart device of FIG. 7.

FIG. 12 is a section view of the smart device of FIG. 7.

FIG. 13 is a schematic sectional diagram of FIG. 7.

FIG. 14 is another exploded perspective view of the smart device of FIG. 7.

FIG. 15 is a top perspective view of a smart device for supporting a dispenser that dispenses a household consumable according to another embodiment.

FIG. 16 is a bottom perspective of view of the smart device of FIG. 15.

FIG. 17 is an exploded view of the smart device of FIG. 15.

FIG. 18 is a sectional view of the smart device of FIG. 15.

FIG. 19 is a schematic sectional diagram of the smart device of FIG. 15.

FIG. 20 is another exploded perspective view of the smart device of FIG. 15.

FIG. 21 is a flow chart of a method of tracking consumption events of a consumable loaded on the smart devices illustrated in FIGS. 7-20 according to an embodiment.

FIG. 22 is a perspective view of a smart device for dispensing a household consumable according to an embodiment.

FIG. 23 is an exploded perspective view of the smart device of FIG. 22.

FIG. 24 is a section view of the smart device of FIG. 22.

FIG. 25 is an enlarged section view of a base of FIG. 24.

FIG. 26 is a perspective sectional view of the base of FIGS. 24 and 25 with some components shown in phantom.

FIG. 27 is a flow chart of a method of tracking consumption events of a consumable being dispensed from the smart device illustrated in FIGS. 22-26 according to an embodiment.

FIG. 28 is a top perspective view of a smart device for a household consumable where the household consumable is illustrated in phantom according to an embodiment.

FIG. 29 is a bottom perspective view of FIG. 28 without the household consumable.

FIG. 30 is an exploded perspective view of the smart device of FIG. 28.

FIG. 31 is a sectional view of a base of the smart device of FIG. 28.

FIG. 32 is a schematic sectional diagram of the base of the smart device of FIG. 28.

FIG. 33 is a top perspective view of a smart device for a household consumable where the household consumable is illustrated in phantom according to an embodiment.

FIG. 34 is a bottom perspective view of the smart device of FIG. 33.

FIG. 35 is an exploded perspective view of the smart device of FIG. 33.

FIG. 36 is a sectional view of a base of the smart device of FIG. 33.

FIG. 37 is a schematic sectional diagram of the base of the smart device of FIG. 33.

FIG. 38 is a flow chart of a method of tracking consumption events of a consumable loaded on the smart devices illustrated in FIGS. 28-37 according to an embodiment.

FIG. 39 is a top perspective view of a smart device for holding a household consumable according to an embodiment.

FIG. 40 is a top perspective view of the smart device of FIG. 39 without the household consumable.

FIG. 41 is a perspective view of an alternative version of the smart device of FIG. 39 without the household consumable.

FIG. 42 is a perspective sectional view of a portion of the smart device shown in FIG. 40.

FIG. 43 is a perspective view of PCBAs used in the smart device shown in FIG. 40.

FIG. 44 is a bottom perspective view of a portion of the smart device shown in FIG. 40 with the lower housing removed.

FIG. 45 is a flow chart of a method of tracking consumption events of a consumable loaded on the smart devices illustrated in FIGS. 39-44.

FIG. 46 is a perspective view of a smart device for dispensing a household consumable in a first position according to an embodiment.

FIG. 47 is a perspective view of the smart device of FIG. 46 in a second position according to an embodiment.

FIG. 48 is an exploded perspective view of the smart device of FIGS. 46 and 47.

FIG. 49 is a section view of the smart device in the first position illustrated in FIG. 46.

FIG. 50 is a section view of the smart device in the second position illustrated in FIG. 47.

FIG. 51 is an enlarged perspective view of the inner tube coupled to the outer tube of the smart device illustrated in FIGS. 46 and 47 where the outer tube is in phantom.

FIG. 52 is an enlarged view of a portion of the exploded perspective view of FIG. 48.

FIG. 53 is an enlarged exploded top view of a portion of the smart device of FIGS. 46 and 47.

FIG. 54 is an enlarged exploded bottom view of a portion of the smart device of FIGS. 46 and 8 where some components are shown in phantom.

FIG. 55 is an enlarged exploded side view of a portion of the smart device of FIGS. 46 and 47 where some components are shown in phantom.

FIG. 56 is a bottom view of the printed circuit board assembly (PCBA) of the smart device illustrated in FIGS. 46-50.

FIG. 57 is a top view of FIG. 56.

FIG. 58 is a side view of FIG. 56.

FIG. 59 is a flow chart of a method of tracking consumption events of a consumable being dispensed from the smart device illustrated in FIGS. 46-50 according to an embodiment.

FIG. 60 is a perspective view of a smart device for a household consumable where the smart device is holding the household consumable according to an embodiment.

FIG. 61 is a perspective sectional view of the smart device and the household consumable of FIG. 60.

FIG. 62 is an exploded perspective view of the smart device of FIGS. 60 and 61.

FIG. 63 is a sectional view of the smart device of FIGS. 60 and 61 in a compressed configuration.

FIG. 64 is a sectional view of the smart device of FIGS. 60 and 61 a decompressed configuration.

FIG. 65 is another exploded perspective view of the smart device of FIGS. 61 and 62.

FIG. 66 is a flow chart of a method of tracking consumption events of a consumable loaded on the smart device illustrated in FIGS. 61-65 according to an embodiment.

### DETAILED DESCRIPTION

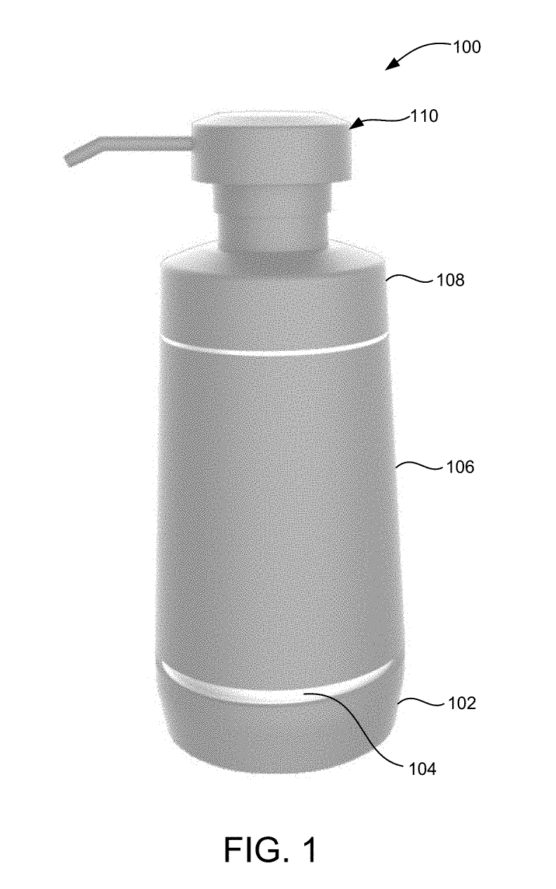

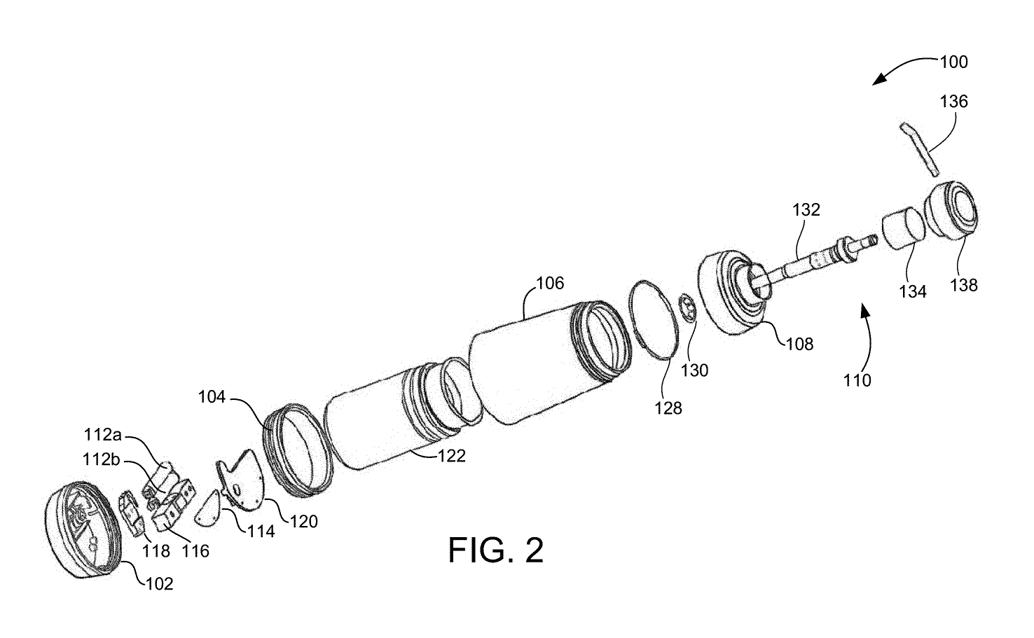

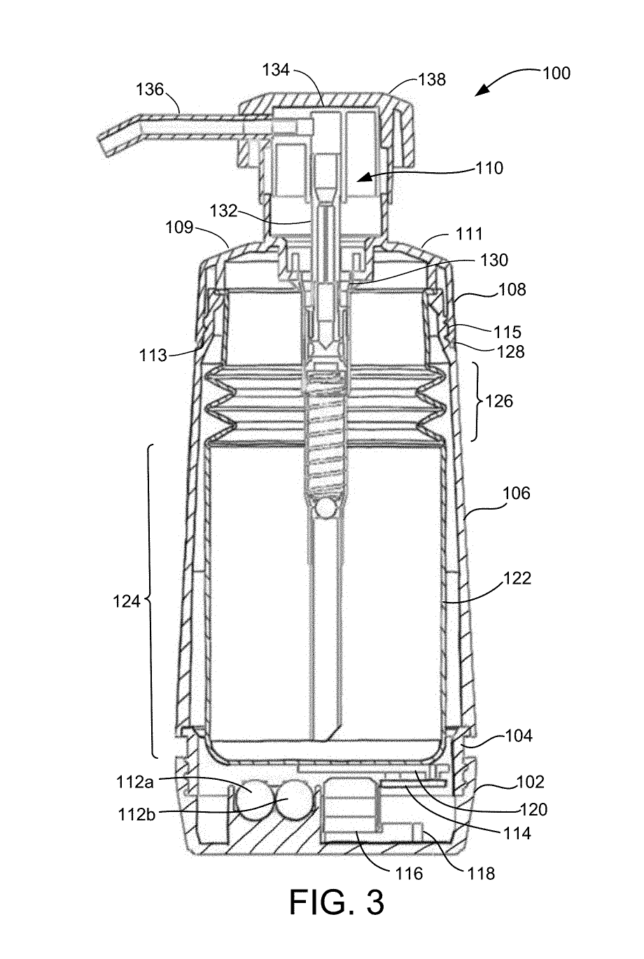

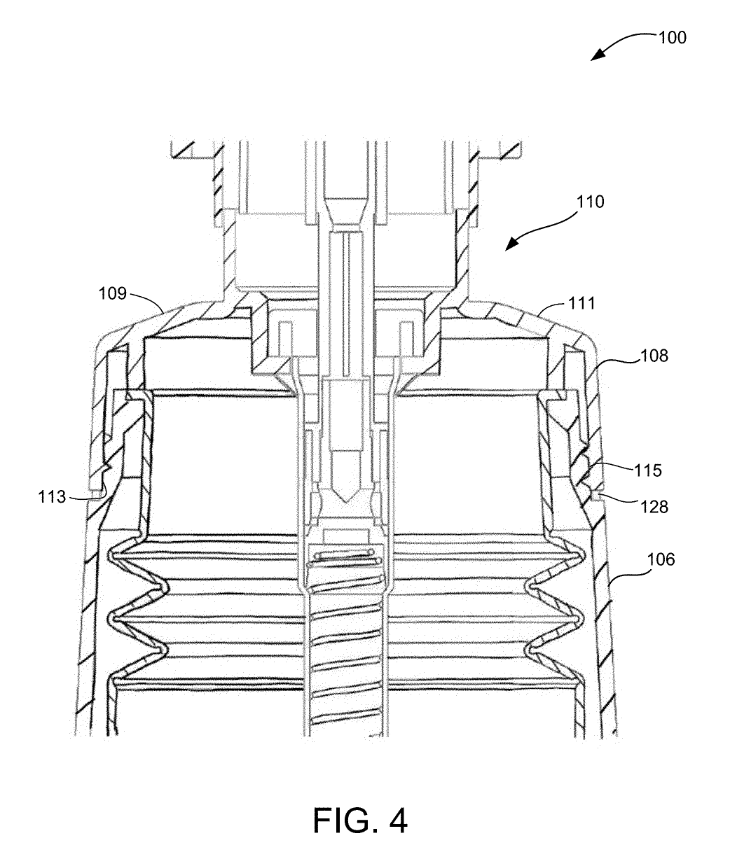

FIG. 1 is a perspective view of a smart device 100 configured for supporting and dispensing a household consumable according to an embodiment. In particular, smart device 100 is a smart liquid dispenser where the household consumable may be liquid soap. FIG. 2 is an exploded perspective view of smart device 100, FIG. 3 is a section view of smart device 100 and FIG. 4 is an enlarged view of a portion of the section view of FIG. 3. As illustrated, smart device 100 includes a base 102, a body base 104, a body 106, a cap 108 and a pump 110.

Base 102 is removably coupled to body base 104 by mating threads on an internal surface of base 102 with threads on an external surface of body base 104. Housed within base 102 are a plurality of internal components including batteries 112a and 112b that are engaged with battery contacts, a processor integrated with a printed circuit board assembly (PCBA) 114, a load cell 116, a load cell mount 118 and a platform 120.

Batteries 112a and 112b power PCBA 114 and load cell assembly 116. In one embodiment, load cell 116 is fastened into a secured position centrally located within base 102 using load cell mount 118. PCBA 114 is attached to a bottom of platform 120 and platform 120 is directly engaged with an internal bag 122 of body 106. The threads on external surface of body base 104 and the threads on internal surface of base 102 allow base 102 to be removably engaged with body base 104 by, for example, unscrewing, to allow for the replacement of batteries 112a and 112b by a user. Body base 104 is fixedly secured to body 106 by, for example, ultrasonic weld.

Smart device 100 is capable of sensing and taking weight or load measurements using load cell 116. A load cell is a sensitive sensor or transducer that is used to create an electrical signal whose magnitude is directly proportional to the force being measured. For example, the load cell may be a strain gauge load cell, however other types of load cells are possible including piezoelectric load cells.

Housed within body 106 is internal bag 122. Internal bag 122 is made of a flexible material, for example, silicone. Internal bag 122 includes main section 124 and an accordion section 126. Internal bag 122 is configured to hold a liquid or other similar consumable, such as soap, that is to be pumped out from internal bag 122 using pump 110. Internal bag 122 acts as a freestanding weight that sits on platform 120 and is weighed by load cell 116. This allows only the weight of internal bag 122 and the material or soap housed in internal bag 122 to be measured rather than the entire body of smart device 100. Main section 124 of internal bag 122 allows the liquid material or soap housed in internal bag to not migrate into body 106 or body base 104 of smart device 100, while accordion section 126 allows internal bag 122 to stretch to rest on platform 120 and be measured by load cell 116. Pump 110 includes pump crimp 130, main pump 132, pump top 134, spout 136 and head 138.

Cap 108 and the components of pump 110 are fixedly assembled together to form a single removable component where cap 108 includes a wide opening. As illustrated in FIGS. 3 and 4, cap 108 includes shoulders 109 and 111 rather than body 106 including shoulders 109 and 111. This provides the entire opening at the top of internal bag 122 being available to a user for refilling soap, which eliminates spillage. Cap 108 includes internal threads located on its internal surface 113. These internal threads on cap 108 mate with external threads located on an external surface 115 of body 106 so that the edge of cap 108 is located adjacent to body ring 128.

Sensing weight in smart device 100 aids in determining different types of consumption events including a “USAGE” event, a “TOTAL USAGE” event and a “REFILL” event. For purposes of simplifying the data derived and reported by smart device 100 as well as making communication with an auto replenishment service or system efficient, the processor keeps a running total of counts in the form of counters for each of these types of consumption events to report to an auto replenishment service or system. The auto replenishment service or system takes these reports and broadcasts them to a prediction engine to determine when the user needs replenishment of the consumable. In addition, the processor may also broadcast to the auto replenishment service or system weight measurements at each count. The weight measurements help the prediction engine predict how much consumable the user has on hand.

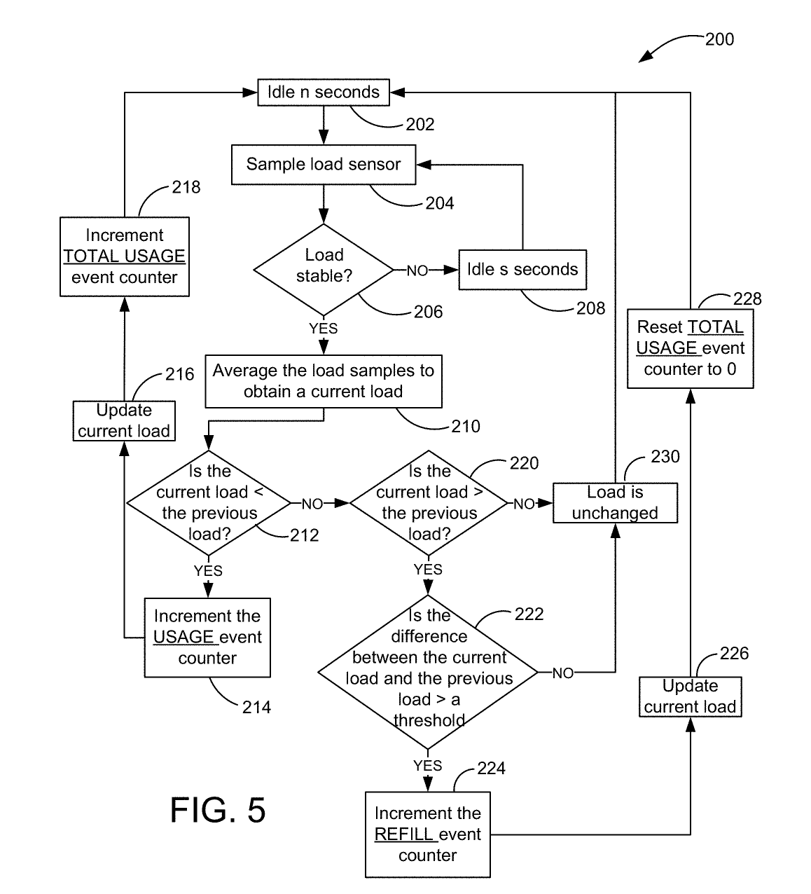

FIG. 5 is a flow chart 200 of a method of tracking consumption of consumables being dispensed by smart device 100 according to an embodiment. At block 202 and upon a user installing a smart soap dispenser and filling liquid soap into the dispenser, such as device 100, the user will fill the liquid soap to a fill indicator line, or in the alternative, the dispenser will come prefilled up to the fill indicator line. The processor sets the weight or load based on this first fill and ensures the total usage event counter is set to zero. At block 202, the processor on PCBA 114 remains idle for n seconds or for an interval of n seconds. In one embodiment, n seconds may be 5 seconds, however, any amount of time is possible as long as the processor is under low power during the n seconds. Under low power, the processor draws less power and conserves battery life.

After n seconds, the method passes to block 204 and the processor samples or polls load cell or sensor 116 m times at q millisecond (ms) intervals. In one embodiment, m is equal to 8 times and q is equal to 50 ms intervals. At block 206, it is determined whether the samples from load cell 116 are stable. For example, if the samples are too dispersed, such as the range of samples are greater than a threshold, then the method passes to block 208 because the load is determined to be unstable or in use. If the range of samples are within the threshold, then the method passes to block 210 because the load is determined to be stable or smart device 100 is at rest. When the method passes to block 208, the processor idles for s seconds, which for example may be 1 second, before resampling load cell 116 at block 204 and repeats this resampling process until the current load is stable or at rest. In one embodiment, only a certain amount of resampling may occur. For example, the processor may be programmed to sample 3 times. After 3 times, the method may pass back to block 202 to idle for n seconds, which is a longer interval of time. When the method passes to block 210, the processor averages the m load samples to obtain a value of the current load.

At block 212, it is determined whether the average value of the current load is less than an average value of the previous load. If the average value of the current load is not less than the average value of the previous load, the method passes to block 220 and it is determined whether the average value of the current load is greater than the average value of the previous load. If the average value of the current load is not greater than the average value of the previous load, then the method passes to block 230 without incrementing the counters of any event because the load is found to be unchanged. If the average value of the current load at block 220 is greater than the average value of the previous load, then the method passes to block 222 where it is determined whether the difference between the average value of the current load and the average value of the previous load is greater than a threshold. When the difference is greater than the threshold, then the processor passes to block 224 and increments the “REFILL” event counter by, for example, a count of one. In this instance, the weight increase is attributed to the dispenser being filled with liquid soap and the “REFILL” event counter is therefore incremented. In one embodiment, the “REFILL” event counter may not be incremented again for t minutes. For example, t minutes may be equal to 1 minute. The method further passes to block 226 to update the average value of the current load, passes to block 228 to reset the “TOTAL USAGE” event counter to 0 and then passes back to block 202 to power down or idle the processor. When the difference is not greater than the threshold, then the processor passes to block 230 without incrementing the counters of any event because the load is found to be generally unchanged.

With reference back to block 212, if the average value of the current load is less than the average value of the previous load, then the method passes to block 214 and the processor increments the “USAGE” event counter by, for example, a count of one. In this instance, the weight decrease is attributed to the dispenser dispensing and liquid soap being used. The method further passes to block 216 to update the average value of the current load, passes to block 218 to increment the “TOTAL USAGE” event counter and then passes back to block 202 to power down or idle the processor. Therefore, when the average value of the current load goes down, the “TOTAL USAGE” event counter goes up.

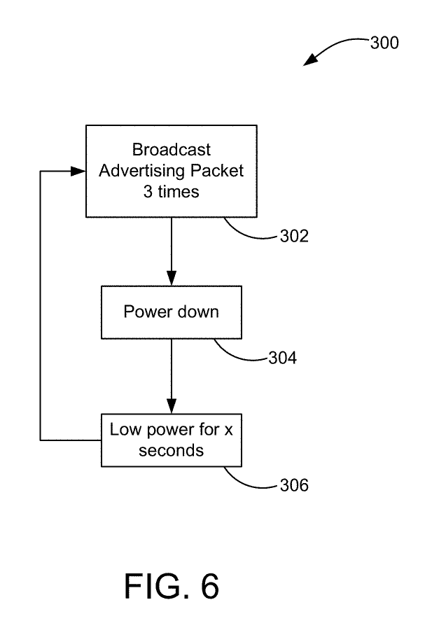

FIG. 6 is a flow chart of a method 300 of reporting consumption events to an auto replenishment service or system. In one embodiment and at block 302, the processor of smart device 100 broadcasts consumption event information to an auto replenishment service or system using Bluetooth®. In particular and in one embodiment, smart device 100 broadcasts an advertising packet 3 times on each of a plurality of Bluetooth® channels including Bluetooth® Low Energy (BLE) channels. An advertising packet includes the current counts for each of the “REFILL”, “USAGE” and “TOTAL USAGE” event counters as well as the current load or weight measurement in order to provide information to a prediction engine of the auto replenishment service or system that aids in refining the prediction engine with more accurate predictions of the user use of liquid soap.

At block 304, the processor of smart device 100 powers down and at block 306 goes into a low power mode for x seconds before passing back to block 302 to again broadcast consumption event information. In this way, smart device 100 keeps periodically transmitting event count data without needing to know whether a receiver was in range to receive the transmitted data. Under one embodiment, a hand held device which has software installed related to the auto replenishment service or system, may receive the transmitted data any time that the handheld device is in range of smart device 100. The handheld device then updates the service or system with the new event information.

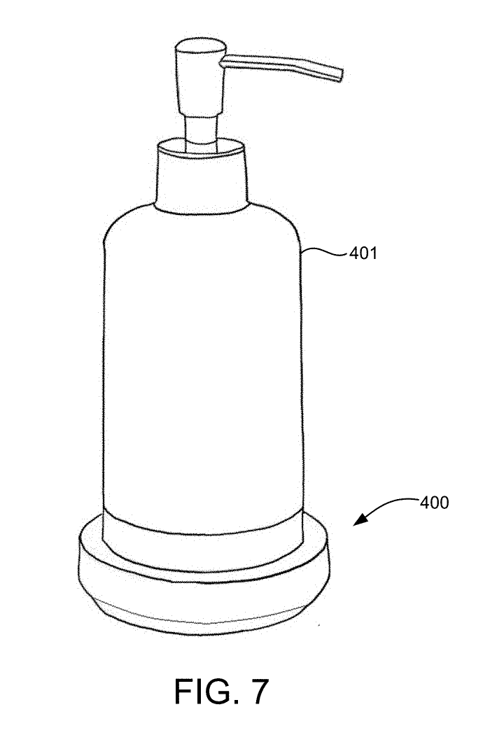

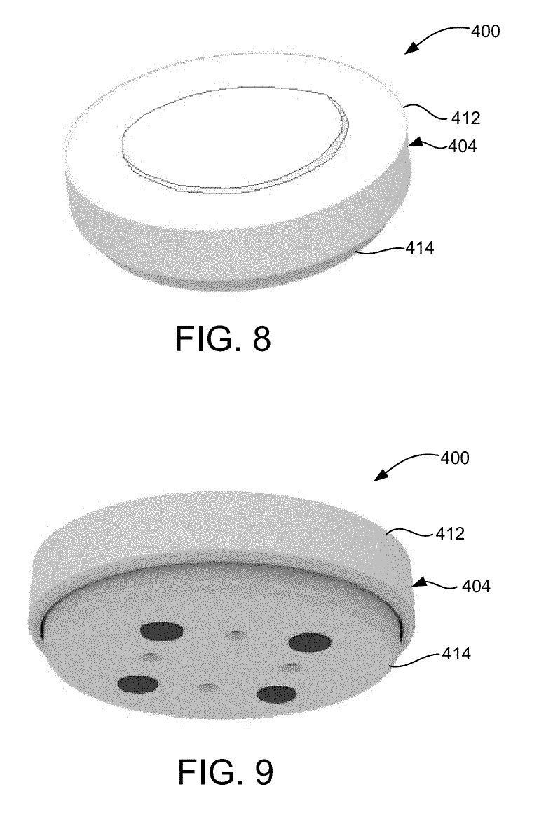

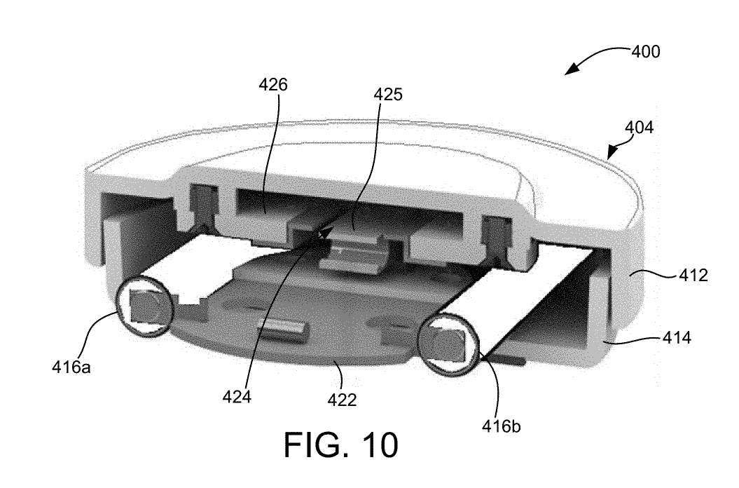

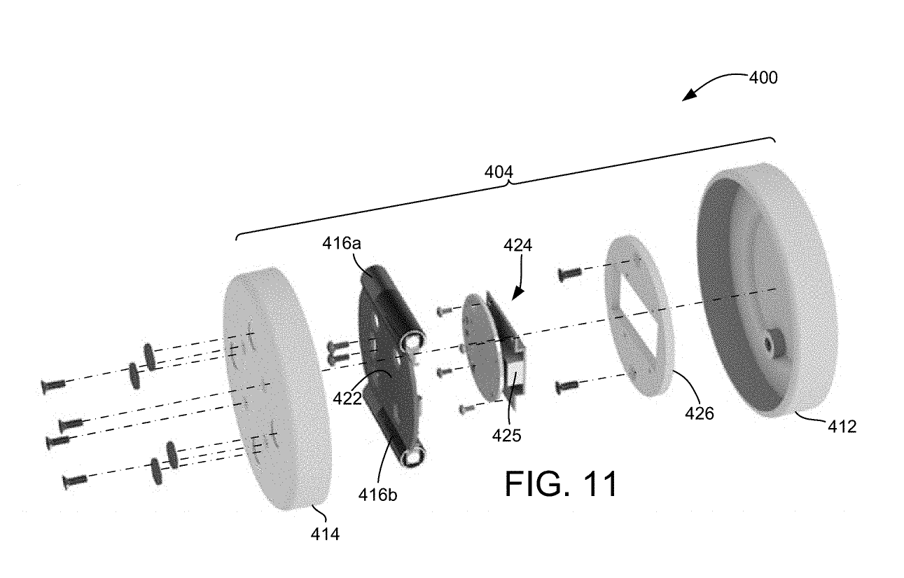

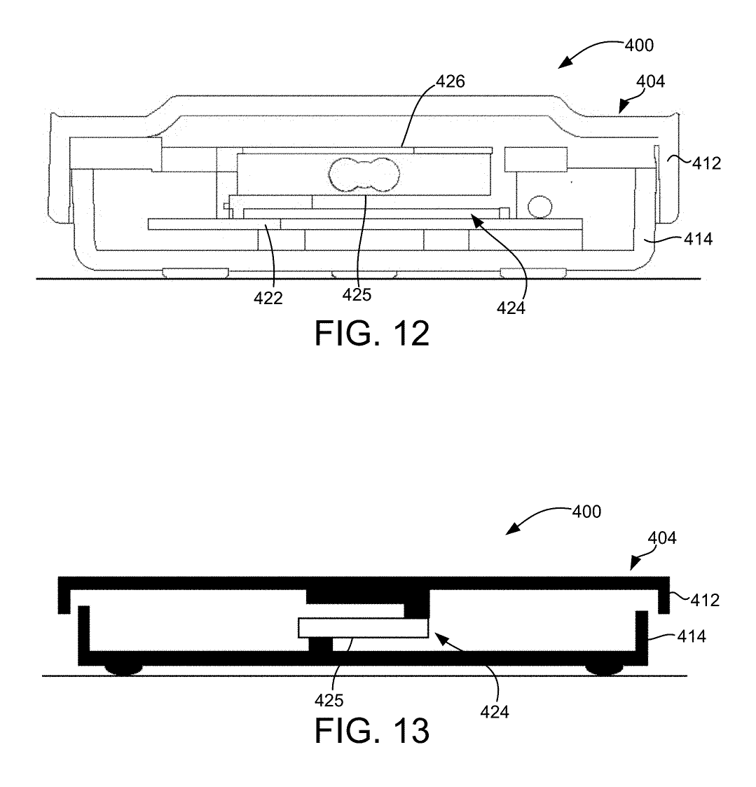

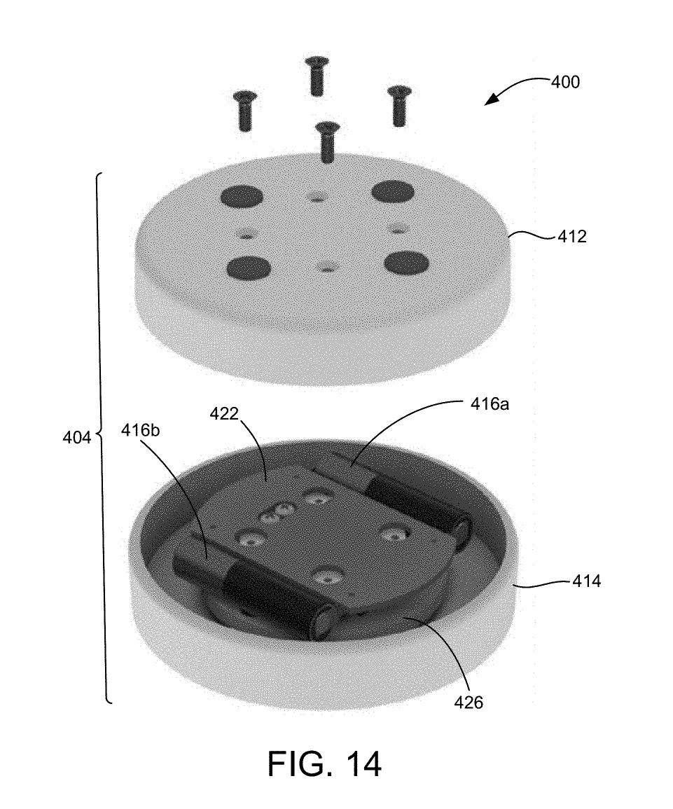

FIG. 7 is a perspective view of another smart device 400 for a smart liquid soap dispenser where the household consumable is liquid soap. Smart device 400 is a puck type object with integrated network connectivity and sensors that supports a dispenser 401 that holds the household consumable of liquid soap according to an embodiment. FIG. 8 is a top perspective view of smart device 400 without the dispenser 401, FIG. 9 is a bottom perspective view, FIG. 10 is a perspective sectional view, FIG. 11 is an exploded perspective view, FIG. 12 is a section view, FIG. 13 is a schematic sectional diagram and FIG. 14 is another exploded perspective view of smart device 400.

As illustrated in FIGS. 8-14, smart device 400 includes a base 404 having an upper housing 412, a lower housing 414 and a plurality of internal components inside base 404. Housed between upper housing 412 and lower housing 414 includes batteries 416a and 416b, a processor integrated with a printed circuit board assembly (PCBA) 422, a load cell assembly 424 and a load cell assembly mount 426. Upper housing 412 has a greater width than lower housing 414. Such overlap, as best illustrated in FIGS. 12 and 13, prevents water intrusion. Load cell assembly 424 includes a single load cell 425 and load cell assembly 424 is located centrally within upper housing 412 and lower housing 414 and fastened with load cell assembly mount 426 between upper and lower housings 412 and 414.

Smart device 400 is capable of sensing and taking weight measurements using load cell 425. Load cell 425 is also capable of sensing spikes in weight, which indicate activity or motion of smart device 400. When load cell 425 senses motion or activity, the processor on PCBA 422 powers up and takes a weight measurement from load cell 425. A load cell is a sensitive transducer that is used to create an electrical signal whose magnitude is directly proportional to the force being measured. For example, load cell 425 may be a strain gauge load cell, however other types of load cells are possible including piezoelectric load cells.

Together, sensed activity or motion and sensed weight aid in determining two types of consumption events determined by smart device 400 including a “SOAP FILLED” consumption event and a “SOAP USAGE” consumption event. For purposes of simplifying the data derived and reported by smart device 400 as well as making communication with an auto replenishment service or system efficient, the processor keeps a running total of counts in the form of counters for each of these two types of consumption events to report to an auto replenishment service or system. The auto replenishment service or system takes these reports and feeds them to a prediction engine to determine when the user needs replenishment of the consumable. In addition, the processor also reports to auto replenishment service or system weight measurements at each count. The weight measurements help the prediction engine predict how much consumable the user has on hand. In this embodiment, the consumables are volumes of liquid soap.

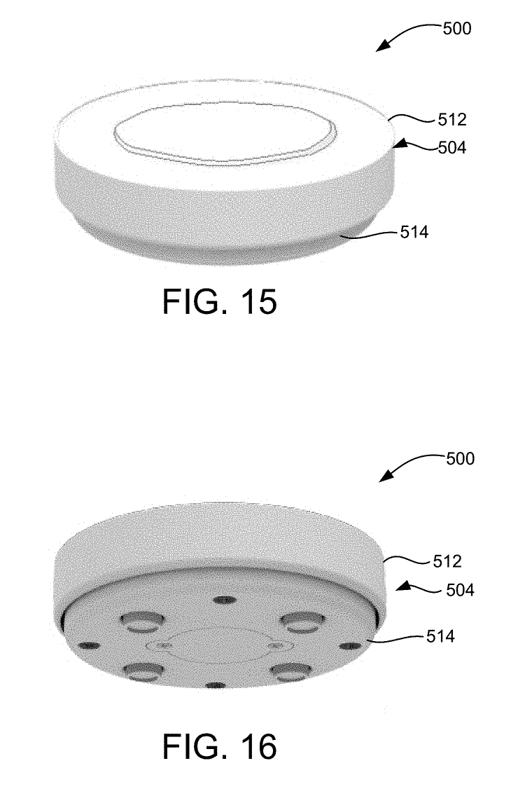

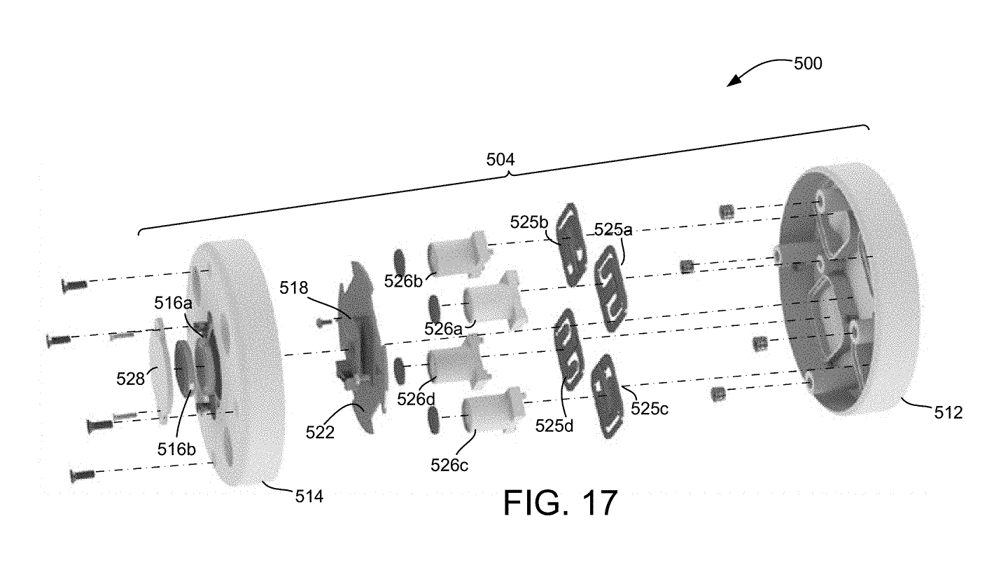

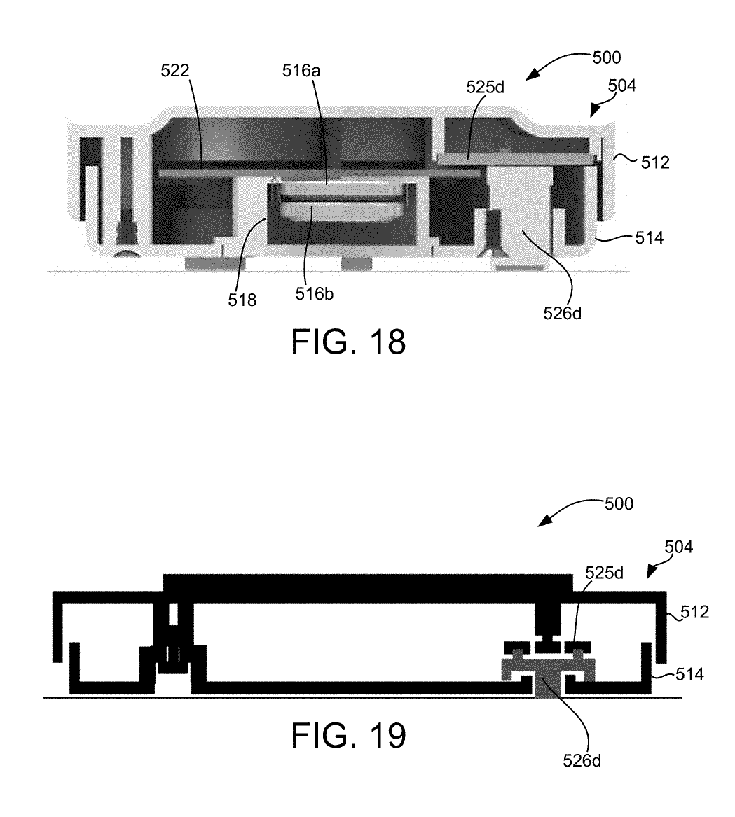

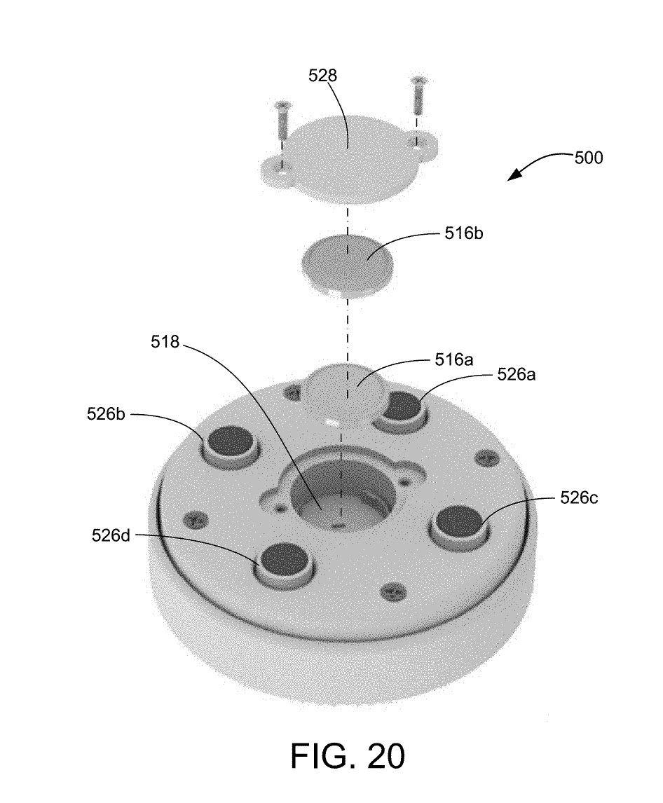

FIG. 15 is a top perspective view of a smart device 500 for a household consumable where the smart device 500 is a puck type object with integrated network connectivity and sensors that supports a dispenser that holds the household consumable of liquid soap, such as dispenser 401, according to an embodiment. FIG. 16 is a bottom perspective view, FIG. 17 is an exploded perspective view, FIG. 18 is a section view, FIG. 19 is a schematic sectional diagram and FIG. 20 is another exploded perspective view of smart device 500.

As illustrated in FIGS. 15-20, smart device 500 includes a base 504 having an upper housing 512, a lower housing 514 and a plurality of internal components inside base 504. Housed between upper housing 512 and lower housing 514 includes batteries 516a and 516b that are mounted into a battery housing 518, a processor mounted to a printed circuit board assembly (PCBA) 522, a plurality of load cells 525a, 525b, 525c and 525d (in this embodiment four load cells), a plurality of feet 526a, 526b, 526c and 526d (in this embodiment four feet) that correspond respectively with each of the plurality of load cells and a battery door 528. Upper housing 512 has a greater width than lower housing 514. Such overlap, as best illustrated in FIGS. 18 and 19, prevents water intrusion.

Smart device 500 is capable of sensing and taking weight measurements using load cells 525a, 525b, 525c and 525d. Load cells 525a, 525b, 525c and 525d are also capable of sensing spikes in weight, which indicate activity or motion of smart device 500. When load cells 525a, 525b, 525c and 525d sense motion or activity, the processor on PCBA 522 powers up and takes a weight measurement from load cells 525a, 525b, 525c and 525d.

Together, sensed activity or motion and sensed weight aid in determining two types of consumption events determined by smart device 500 including a “SOAP FILLED” consumption event and a “SOAP USAGE” consumption event. For purposes of simplifying the data derived and reported by smart device 500 as well as making communication with an auto replenishment service or system efficient, the processor keeps a running total of counts in the form of counters for each of these two types of consumption events to report to an auto replenishment service or system. The auto replenishment service or system takes these reports and feeds them to a prediction engine to determine when the user needs replenishment of the consumable. In addition, the processor also reports to the auto replenishment service or system weight measurements at each count. The weight measurements help the prediction engine predict how much consumable the user has on hand. In this embodiment, the consumables are volumes of liquid soap, but could be other types of consumables including volumes of lotion.

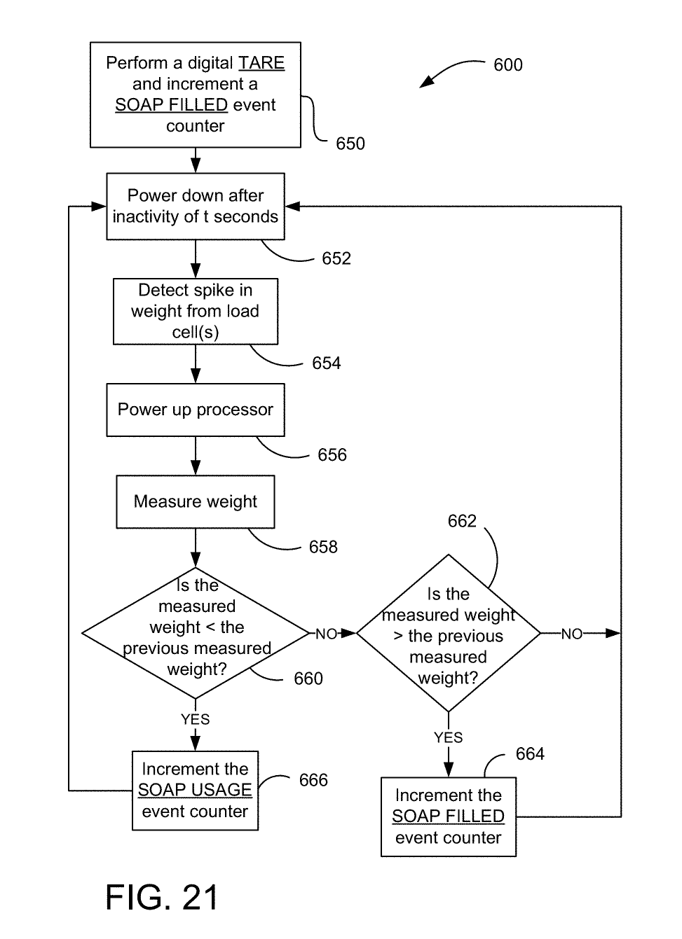

FIG. 21 is a flow chart 600 of a method of tracking consumption events of a consumable loaded on smart devices 400 and 500 according to an embodiment. At block 650 and upon a user installing a smart soap dispenser and filling liquid soap into the dispenser, such as dispenser 401, the processor on PCBA 422, 522 performs a digital TARE and increments a “SOAP FILLED” event counter. In one embodiment and upon first use of smart device 400 and 500, the user will fill the liquid soap to a fill indicator line, or in the alternative, the dispenser will come prefilled up to the fill indicator line. The digital TARE sets the weight to zero for the liquid so as to discern changes in weight when liquid soap is dispensed or when liquid soap is filled. At block 652, the processor powers down after t seconds of inactivity. In one example, t seconds may be 30 seconds, however, any amount of time is possible as long as after a set amount of time the processor is triggered to go into sleep mode. In sleep mode, the processor draws less power and conserves battery life.

At block 654, load cells, such as load cell 425 or load cells 525a, 525b, 525c and 525d, detect or sense a spike in weight, which indicates activity or motion resulting in the processor being powered up at block 656. The processor then takes a weight measurement at block 658. In one embodiment, the processor may be programmed to wait to take the weight measurement for t seconds in order for the activity to finish and to get an accurate weight reading. For example, t seconds may be 30 seconds. At block 660, it is determined whether the measured weight is less than the previous measured weight. If the measured weight is not less than the previous measured weight, the method passes to block 662 and it is determined whether the measured weight is greater than the previous measured weight. If the measured weight is not greater than the previous measured weight, then the method passes back to block 652 without incrementing the counters of any event. In this instance, there is little to no change in weight and the activity may be attributed to the user fiddling with or moving smart device 400 or 500. If the measured weight at block 662 is greater than the previous measured weight, then the method passes to block 664 and the processor increments the “SOAP FILLED” event counter by, for example, a count of one and passes back to block 652 to power down. In this instance, the weight increase is attributed to the dispenser being filled with liquid soap. With reference back to block 660, if the measured weight is less than the previous measured weight, then the method passes to block 666 and the processor increments the “SOAP USAGE” event counter by, for example, a count of one and passes back to block 652 to power down. In this instance, the weight decrease is attributed to the dispenser being used.

Under one embodiment, the processors of FIGS. 7-21 report consumption events to an auto replenishment service or system as shown in flow chart 300 of FIG. 6. In one embodiment, smart devices 400 and 500 communicate and report consumption event information to an auto replenishment service or system using Bluetooth®. In still another embodiment, smart devices 400 and 500 communicate and reports consumption event information to the auto replenishment service or system using Bluetooth® Low Energy (BLE). In addition and under one embodiment, smart devices 400 and 500 transmit consumption event information periodically.

As illustrated in FIG. 6, at block 302, the processor in smart devices 400 and 500 broadcast the current counts for each of the “SOAP FILLED” and “SOAP USAGE” event counters. At block 304, smart devices 400 and 500 power down and at block 306 goes into sleep mode for t seconds before passing back to block 302 to transmit consumption event information. In this way, smart devices 400 and 500 keep periodically transmitting event count data without needing to know whether a receiver was in range to receive the transmitted data. Under one embodiment, a hand held device which has software installed related to the auto replenishment service or system, may receive the transmitted data any time that the handheld device is in range of smart devices 400 and 500. The handheld device then updates the service or system with the new event information. In some embodiments, smart devices 400 and 500 may transmit more information than counts of “SOAP FILLED” and “SOAP USAGE” events including weight measurements in order to provide information to a prediction engine of the auto replenishment service or system that aids in refining the prediction engine with more accurate predictions of the user use of liquid soap.

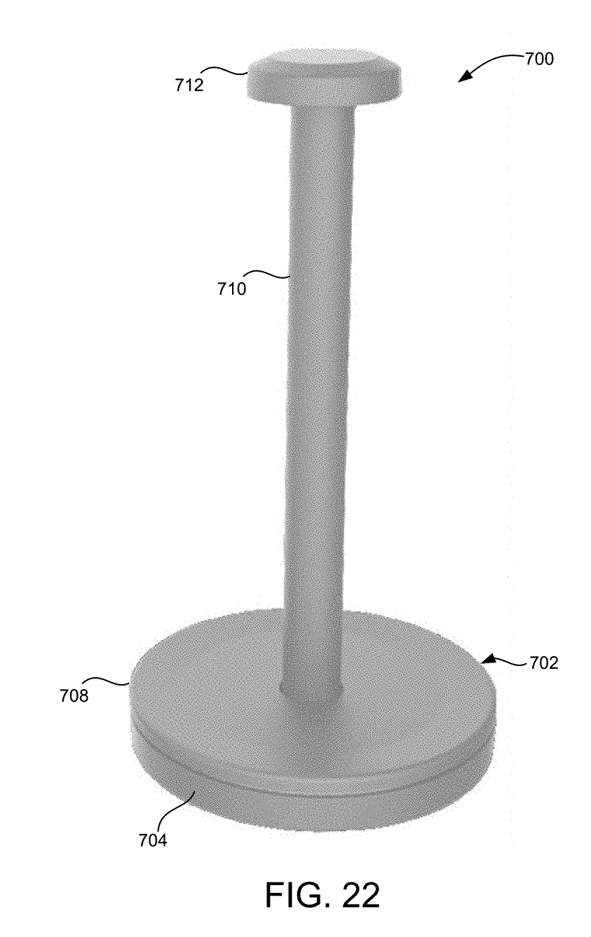

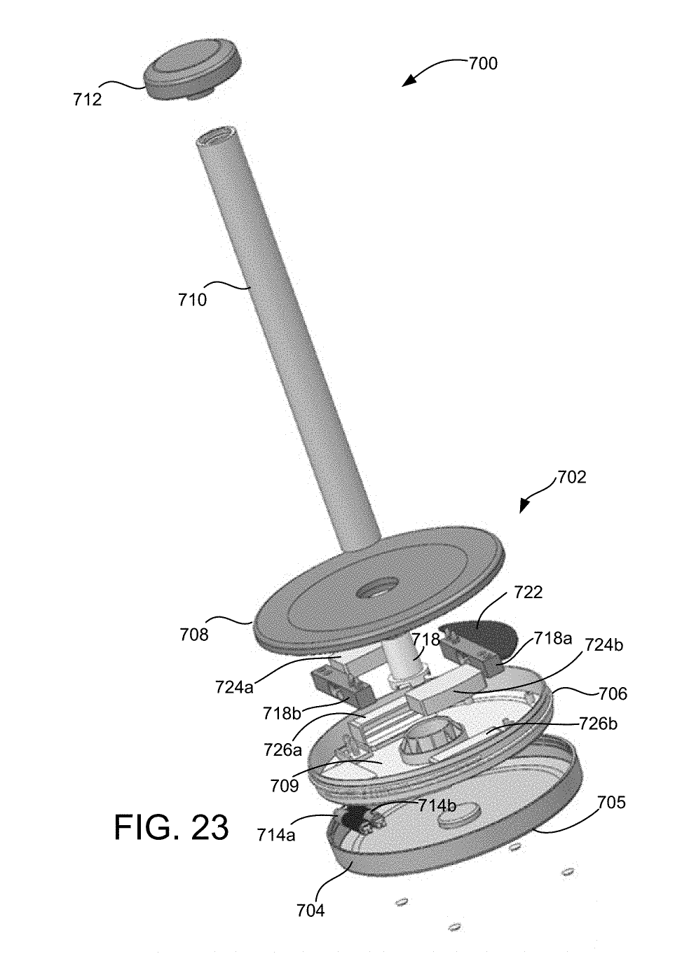

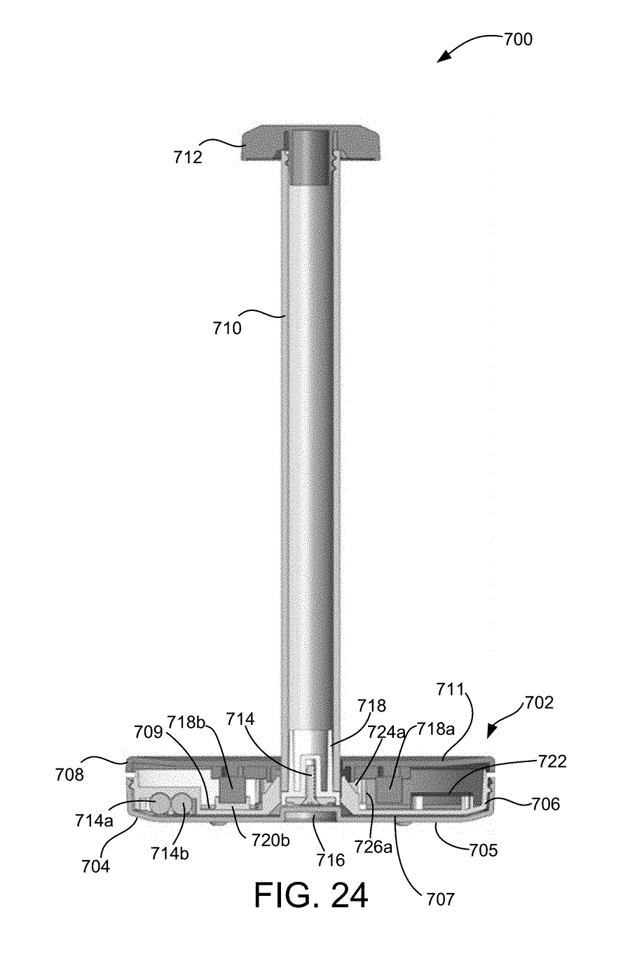

FIG. 22 is a perspective view of a smart device 700 for dispensing a household consumable according to an embodiment. FIG. 23 is an exploded perspective view of smart device 700 and FIG. 24 is a section view of smart device 700. In particular, smart device 700 is a smart paper towel holder where the household consumable is a roll of paper towels. However, other types of consumables are possible including toilet paper rolls. Smart device 700 has a base 702 that includes a bottom case 704, a middle case 706 and an upper case 708. Smart device 700 further includes a cylindrical shaft 710 and a top head 712 that is removably coupled to a top of cylindrical shaft 710 so as to receive and secure the consumable, such as a roll of paper towels. Upper case 708 and middle case 706 are affixed together, by for example, welding or adhesive, while bottom case 704 is rotatably removable from middle case 706 so as to provide tool-less access to, for example, the changing of batteries 714a and 714b. However, other reasons for making the inside of base 702 accessible includes performing a factory reset and accessing LED error codes. Bottom case 704 includes a thumb indent 716 that is recessed from a bottom surface 705 of bottom case 704. Thumb indent 716 aids a user in unscrewing or rotatably removing bottom case 704 from middle case 706.

Shaft 710 couples to base 702 with a single fastener 714 that is housed in cylinder base 718. Cylinder base 718 is mounted to an inside of a bottom end of shaft 710 and is fastened to middle case 706 and upper case 708 with fastener 714, which in one embodiment is a flat head screw. This connection provides a structurally sound cylindrical shaft 710 for receiving consumables, such as a roll of paper towels.

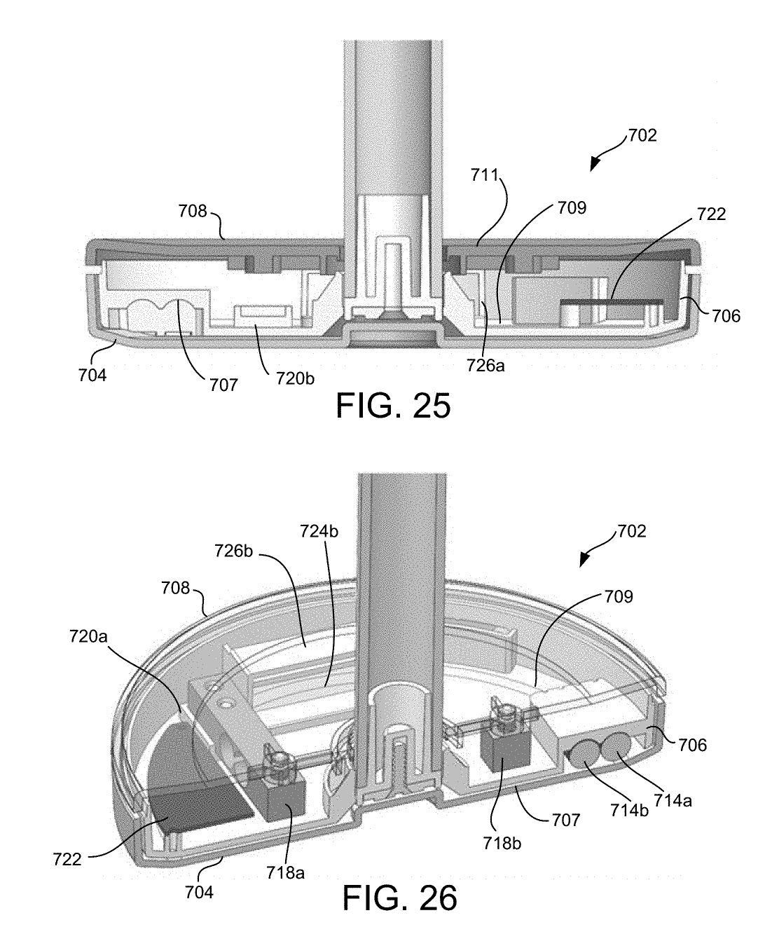

The components that enable smart device 700 to sense activity, connect with a network and report consumption events and therefore be part of the IoT are housed within base 702. FIG. 25 is an enlarged section view of base 702 and FIG. 26 is an enlarged perspective sectional view of base 702. As illustrated, base 702 includes a plurality of internal components. Housed in and coupled to a bottom surface 707 of middle case 706 includes batteries 714a and 714b. Housed in and mounted to a top surface 709 of middle case 706 are a pair of load cells 718a and 718b (however it should be realized that at least one load cell is possible). The pair of load cells 718a and 718b are mounted to middle case 706 with a pair of load cell mounts 720a and 720b, a printed circuit board assembly (PCBA) 722 having a processor and a pair of weights 724a and 724b (however it should be realized that at least one weight is possible). The pair of weights 724a and 724b are mounted to middle case 706 with a pair of mounts 726a and 726b.

Smart device 700 is capable of sensing and taking weight measurements using, for example, load cells 718a and 718b. A load cell is a sensitive transducer that is used to create an electrical signal whose magnitude is directly proportional to the force being measured. For example, load cells 718a and 718b may be a strain gauge load cells, however other types of load cells are possible including piezoelectric load cells.

Sensing weight in smart device 700 aids in determining different types of consumption events including a “NEW ROLL” consumption event, a “ROLL REMOVAL” consumption event, an “INSERTION” consumption event and a “USAGE” consumption event. For purposes of simplifying the data derived and reported by smart device 700 as well as making communication with an auto replenishment service or system efficient, processor 722 keeps a running total of counts in the form of counters for each of these types of consumption events to report to an auto replenishment service or system. The service or system takes these reports and broadcasts them to a prediction engine to determine when the user needs replenishment of the consumable. In addition, processor 722 may also broadcast to the auto replenishment service or system weight measurements at each count. The weight measurements help the prediction engine predict how much consumable the user has on hand.

Weights 724a and 724b that are mounted to middle case 706 provide stability to smart device 700 so that smart device 700 sits stably on top of a table or countertop. A top surface 711 of upper case 708 is not completely planar. As illustrated in FIGS. 24 and 25, top surface 711 includes an angled portion located around the outer circumference of upper case 708 and a flat portion located around the inner circumference or adjacent to the shaft 710. The angled portion provides friction to the consumable, such as the paper towels located on the roll of paper towels, so that pieces of paper towel can be broken off the main sheet.

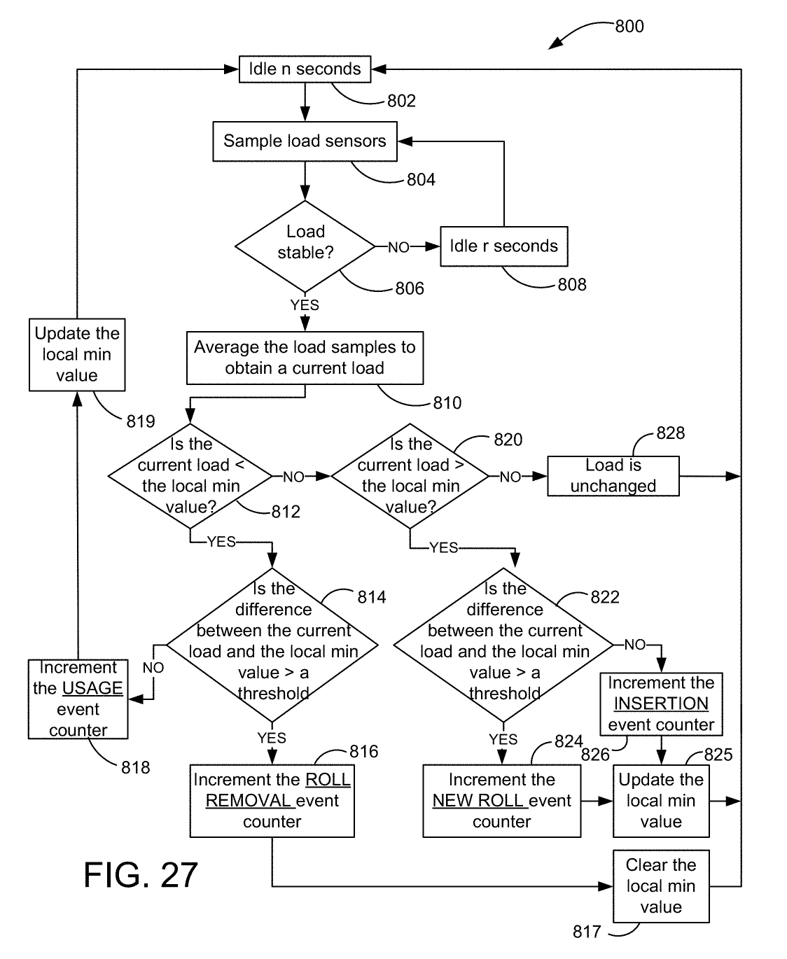

FIG. 27 is a flow chart 800 of a method of tracking consumption of a consumable loaded on smart device 700 according to an embodiment. At block 802 and upon a user installing a smart paper tower holder and inserting a new roll on shaft 710, processor 722 remains idle for n seconds. In one embodiment, n seconds may be 5 seconds, however, any amount of time is possible as long as after and interval of n seconds processor 722 is triggered to power down. Under low power, processor 722 draws less power and conserves battery life.

After n seconds, the method passes to block 804 and processor 722 samples or polls load cells or sensors 718a and 718b p times at x milliseconds (ms) intervals. In one embodiment, p is equal to 8 times and x is equal to 50 ms intervals. At block 806, it is determined whether the samples from load cells 718a and 718b are stable. For example, if the samples are too dispersed, such as the range of samples are greater than a threshold, then the method passes to block 808 because the load is determined to be unstable or in use. If the range of samples are within the threshold, then the method passes to block 810 because the load is determined to be stable or smart device 700 is at rest. When the method passes to block 808, processor 722 idles for r seconds, which for example may be 1 second, before resampling load cells 718a and 718b at block 804 and repeats this resampling process until the current load is stable or at rest. Under one embodiment, only a certain amount of resampling will occur. For example, processor 722 may be programmed to sample 3 times. After 3 times, the method may pass back to block 802 to idle for n seconds, which is a longer interval of time. When the method passes to block 810, processor 722 averages the p load samples to obtain an average value of the current load.

At block 812, it is determined whether the average value of the current load is less than a local min value, which is an average value of the previous load. The local min value is not reported to the auto replenishment system. If the average value of the current load is not less than the local min value, the method passes to block 820 and it is determined whether the average value of the current load is greater than the local min value. If the value of the current load is not greater than the local min value, then the method passes to block 830 without incrementing the counters of any event because the load is found to be unchanged. If the average value of the current load at block 820 is greater than the local min value, then the method passes to block 822 where it is determined whether the difference between the average value of the current load and the local min value is greater than a threshold. When the difference is greater than the threshold, then processor 722 passes to block 824 and increments the “NEW ROLL” event counter by, for example, a count of one. In this instance, the weight increase is attributed to a new roll of paper towel being inserted onto shaft 710 and, under one embodiment, the “NEW ROLL” event counter may not be incremented again for s minutes. For example, s minutes may be equal to 1 minute. At block 825 and upon incrementing the “NEW ROLL” event counter, the method further updates the local min value with the average value of the current load and then passes back to block 802 to power down or idle processor 722. When the difference is not greater than the threshold, then the method passes to block 826 and increments the “INSERTION” event counter by, for example, a count of one. In this instance, the weight increase is attributed to sheets of paper towel that have been previously removed being placed back in with the roll. The method passes to block 825 and upon incrementing the “INSERTION” event counter, the method further updates the local min value with the average value of the current load and then passes back to block 802 to power down or idle processor 722.

With reference back to block 812, if the average value of the current load is less than the local min value, then the method passes to block 814 where it is determined whether the difference between the average value of the current load and the local min value is greater than a threshold. When the difference is greater, then processor passes to block 816 and increments the “ROLL REMOVAL” event counter by, for example, a count of one. In this instance, the weight decrease is attributed to the roll being removed from shaft 710. At block 817 and upon incrementing the “ROLL REMOVAL” event counter, the method further clears the local min value and then passes back to block 802 to power down or idle processor 722. When the difference is not greater than the threshold, then processor 722 passes to block 818 and increments the “USAGE” event counter by, for example, a count of one. In this instance, the weight decrease is attributed to sheets of paper towel being used from the roll. The method passes to block 819 and upon incrementing the “USAGE” event counter, the method further updates the local min value with the average value of the current load and then passes back to block 802 to power down or idle.

Under one embodiment, processor 722 reports consumption events to an auto replenishment service or system as shown in flow chart 300 of FIG. 6. In one embodiment and at block 302, processor 722 of smart device 700 broadcasts consumption event information to an auto replenishment service or system using Bluetooth®. In particular and under one embodiment, processor 722 broadcasts an advertising packet 3 times on each of a plurality of Bluetooth® channels including Bluetooth® Low Energy (BLE) channels. An advertising packet includes the current counts for each of the “NEW ROLL” event, “INSERTION” event, “ROLL REMOVAL” event and “USAGE” event. In addition and under one embodiment, smart device 700 may transmit other consumption event information including sensor readings and counts of sensed activity in order to provide information to a prediction engine of the auto replenishment service or system that aids in refining the prediction engine with more accurate predictions of the user use of toilet paper rolls.

At block 304, processor 722 powers down and at block 306 goes into a low power mode for x seconds, such as 30 seconds, before passing back to block 302 to again broadcast consumption event information. In this way, smart device 700 keeps periodically transmitting event count data without needing to know whether a receiver was in range to receive the transmitted data. Under one embodiment, a hand held device which has software installed related to the auto replenishment service or system, may receive the transmitted data any time that the handheld device is in range of smart device 700. The handheld device then updates the service or system with the new event information.

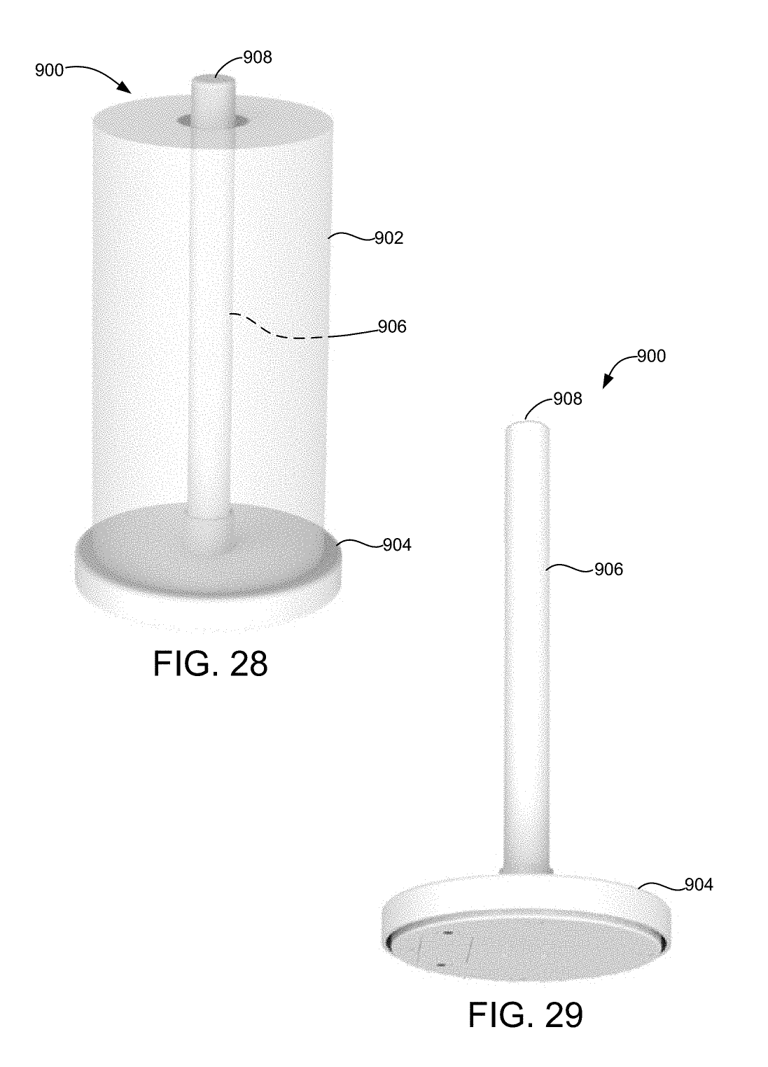

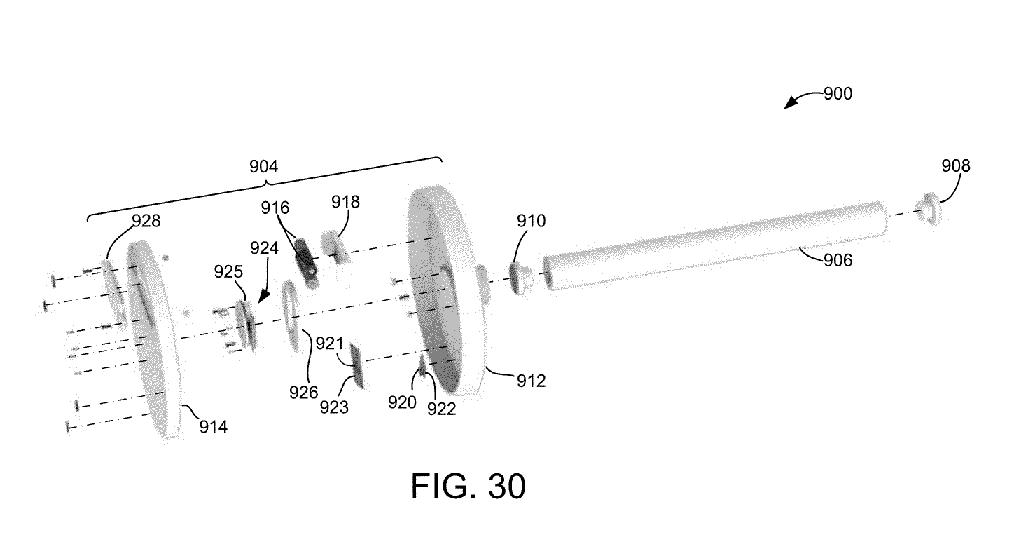

FIG. 28 is a top perspective view of a smart device 900 for a household consumable 902 where household consumable 902 is illustrated in phantom according to an embodiment. FIG. 29 is a bottom perspective view of smart device 900 of FIG. 28 without household consumable 902. In particular, smart device 900 is a smart paper towel holder where household consumable 902 is a roll of paper towels. However, other types of consumables are possible including toilet paper rolls. Smart device 900 includes a base 904, a spindle 906, a top cap 908 and a bottom cap (illustrated in FIGS. 30 and 31) that connects spindle 906 to base 904. The components that enable device 900 to sense activity, connect with a network and report consumption events and therefore be part of the IoT are housed within base 904.

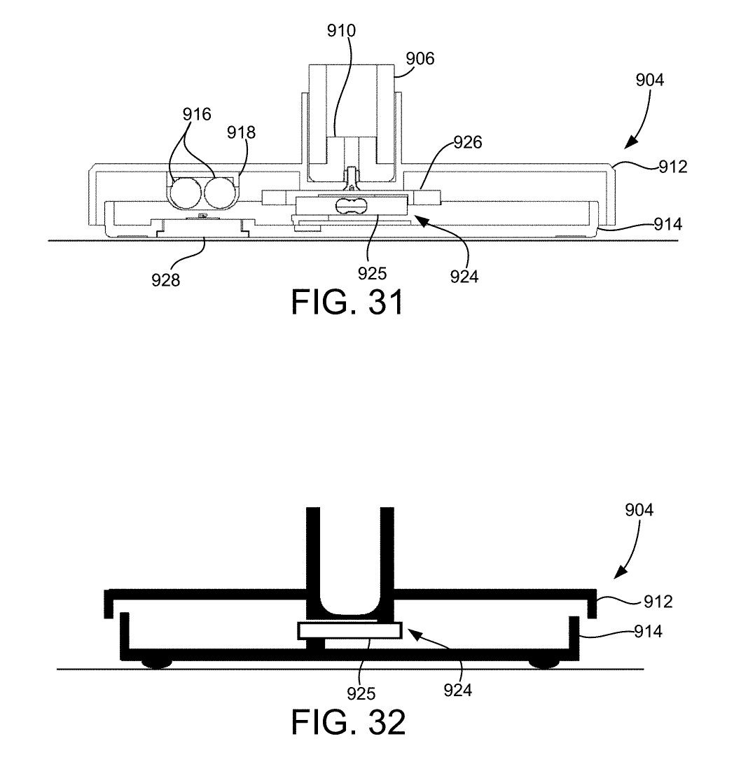

FIG. 30 is an exploded perspective view of smart device 900, FIG. 31 is a sectional view of base 904 of smart device 900 and FIG. 32 is a schematic sectional diagram of base 904 of smart device 900. As illustrated in FIGS. 30-32, base 904 includes an upper housing 912, a lower housing 914 and a plurality of internal components. Housed between upper housing 912 and lower housing 914 includes batteries 916 that are mounted into a battery housing 918, a vibration sensor 920 mounted to a printed circuit board assembly (PCBA) 922, a processor 921 mounted to a printed circuit board assembly (PCBA) 923, a load cell assembly 924, a load cell assembly mount 926 and a battery door 928. Upper housing 912 has a greater width than lower housing 914. Such overlap, as best illustrated in FIGS. 31 and 32, prevents water intrusion. Load cell assembly 924 includes a single load cell 925 and load cell assembly 924 is located centrally within upper housing 912 and lower housing 914 and fastened with load cell assembly mount 926 between upper and lower housings 912 and 914.

Besides smart device 900 being capable of sensing and taking weight measurements using load cell 925, smart device 900 is also capable of sensing activity or motion of smart device 900 with vibration sensor 920. When vibration sensor 920 (mounted to PCBA 922) senses motion or activity, processor 921 on PCBA 923 powers up and takes a weight measurement from load cell 925 on load cell assembly 924. A load cell is a sensitive transducer that is used to create an electrical signal whose magnitude is directly proportional to the force being measured. For example, load cell 925 may be a strain gauge load cell, however other types of load cells are possible including piezoelectric load cells.

Together, sensed activity or motion and sensed weight aid in determining three types of consumption events determined by smart device 900 including a “NEW ROLL” consumption event, a “ROLL REMOVAL” consumption event and a “ROLL USAGE” consumption event. For purposes of simplifying the data derived and reported by smart device 900 as well as making communication with an auto replenishment service or system efficient, processor 921 keeps a running total of counts in the form of counters for each of these three types of consumption events to report to an auto replenishment service or system. The service or system takes these reports and feeds them to a prediction engine to determine when the user needs replenishment of the consumable. In this embodiment, the consumables are rolls of paper towels.

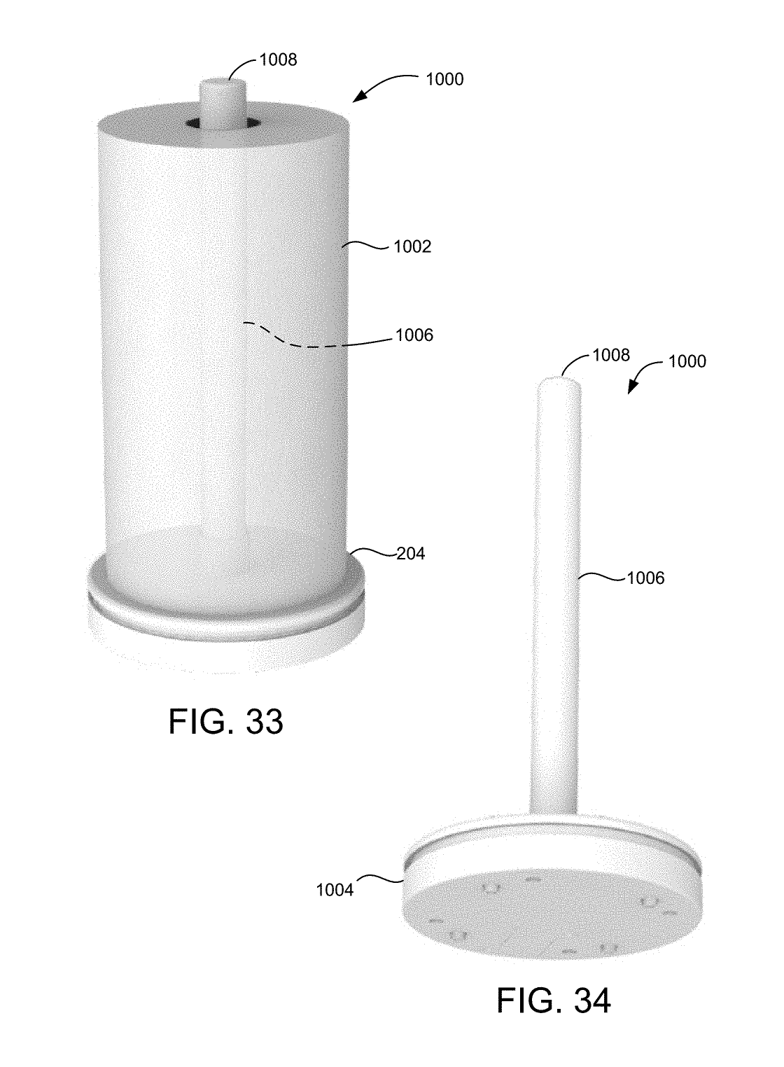

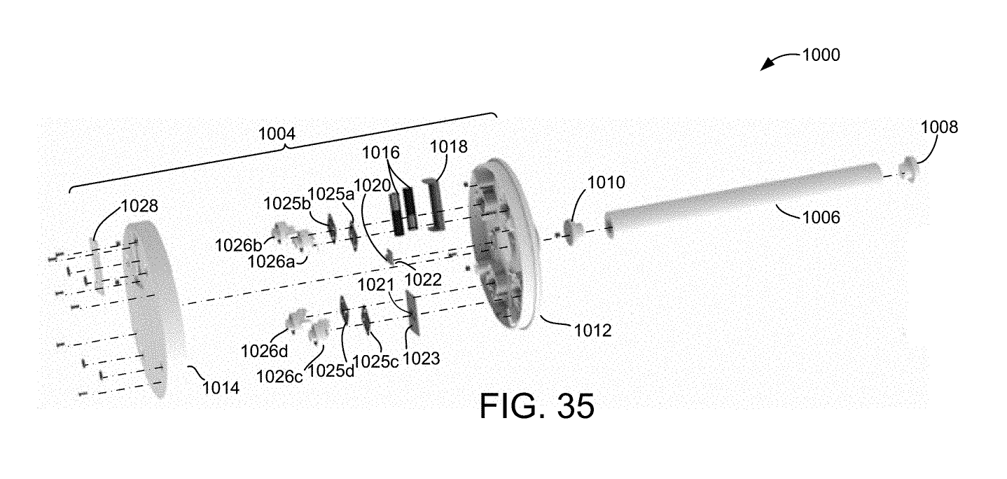

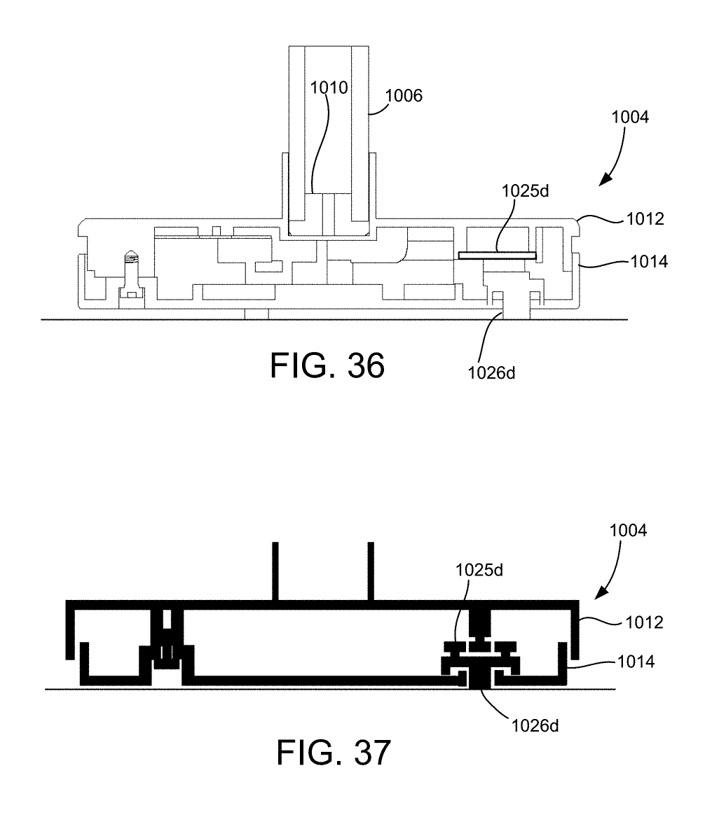

FIG. 33 is a top perspective view of a smart device 1000 for a household consumable 1002 where household consumable 1002 is illustrated in phantom according to an embodiment. FIG. 34 is a bottom perspective view of smart device 1000 of FIG. 35 without household consumable 1002. In particular, smart device 1000 is a smart paper towel holder where household consumable 1002 is a roll of paper towels. Smart device 1000 includes a base 1004, a spindle 1006, a top cap 1008 and a bottom cap (illustrated in FIGS. 35 and 36) that connects spindle 1006 to base 1004. The components that enable device 1000 to sense activity, connect with a network and report consumption events and therefore be part of the IoT are housed within base 1004.

FIG. 35 is an exploded perspective view of smart device 1000, FIG. 36 is a sectional view of base 1004 of smart device 1000 and FIG. 37 is a schematic sectional diagram of base 1004 of smart device 1000. As illustrated in FIGS. 35-37, base 1004 includes an upper housing 1012, a lower housing 1014 and a plurality of internal components. Housed between upper housing 1012 and lower housing 1014 includes batteries 1016 that are mounted into a battery housing 1018, a vibration sensor 1020 mounted to a printed circuit board assembly (PCBA) 1022, a processor 1021 mounted to a printed circuit board assembly (PCBA) 1023, a plurality of load cells 1025a, 1025b, 1025c and 1025d (in this embodiment four load cells), a plurality of feet 1026a, 1026b, 1026c and 1026d (in this embodiment four feet) that correspond respectively with each of the plurality of load cells and a battery door 1028. Upper housing 1012 has a greater width than lower housing 1014. Such overlap, as best illustrated in FIGS. 36 and 37, prevents water intrusion.

Besides smart device 1000 being capable of sensing and taking weight measurements using load cells 1025a, 1025b, 1025c and 1025d, smart device 1000 is also capable of sensing activity or motion of smart device 1000 with vibration sensor 1020. When vibration sensor 1020 (mounted to PCBA 1022) senses motion or activity, processor 1021 on PCBA 1023 powers up and takes a weight measurement from load cells 1025a, 1025b, 1025c and 1025d.

Together, sensed activity or motion and sensed weight aid in determining three types of consumption events determined by smart device 1000 including a “NEW ROLL” consumption event, a “ROLL REMOVAL” consumption event and a “ROLL USAGE” consumption event. For purposes of simplifying the data derived and reported by smart device 1000 as well as making communication with an auto replenishment service or system efficient, processor 1021 keeps a running total of counts in the form of counters for each of these three types of consumption events to report to an auto replenishment service or system. The service or system takes these reports and feeds them to a prediction engine to determine when the user needs replenishment of the consumable. In this embodiment and as previously mentioned, the consumables are rolls of paper towels.

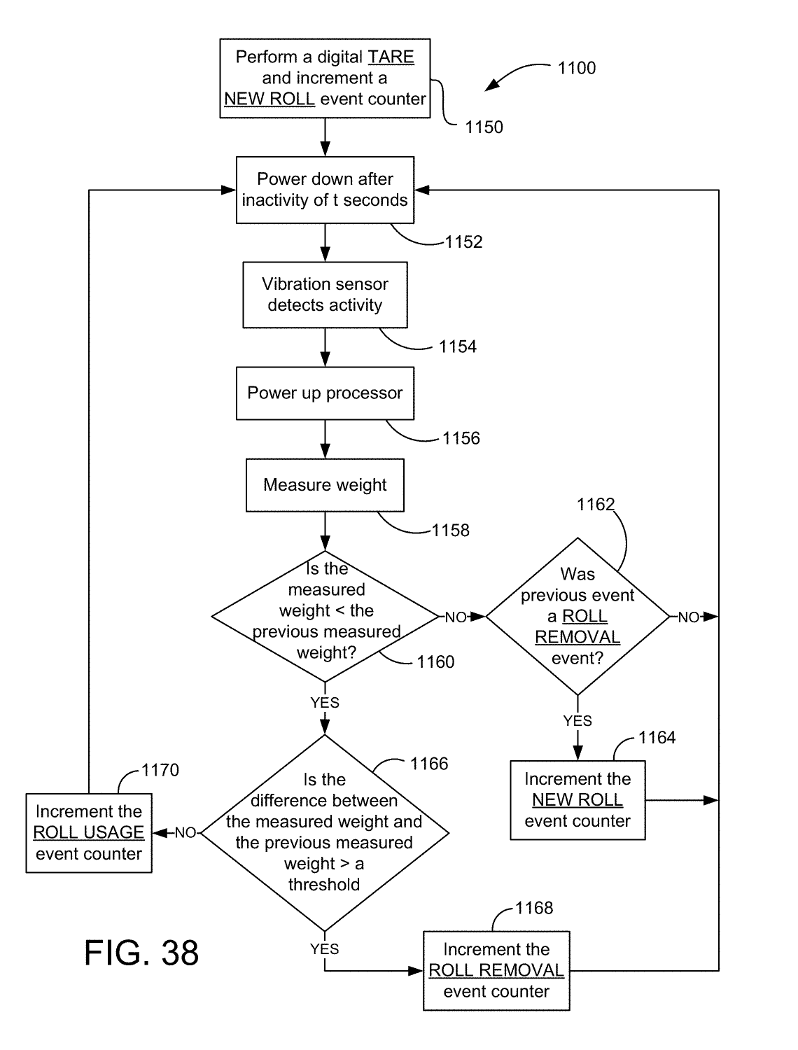

FIG. 38 is a flow chart 1100 of a method of tracking consumption events of a consumable loaded on smart devices 900 and 1000 according to an embodiment. At block 1150 and upon a user installing a smart paper tower holder and inserting a new roll on spindle 906, 1006, processor 921, 1021 performs a digital TARE and increments a NEW ROLL event counter. The digital TARE sets the weight to zero for the new roll so as to discern changes in weight when a roll is removed or when rolls are used. At block 1152, processor 921, 1021 powers down after t seconds of inactivity. In one example, t seconds may be 30 seconds, however, any amount of time is possible as long as after a set amount of time processor 921, 1021 is triggered to go into sleep mode. In sleep mode, processor 921, 1021 draws less power and conserves battery life.

At block 1154, vibration sensor 920, 1020 detects or senses activity or motion resulting in processor 921, 1021 being powered up at block 1156. Processor 921, 1021 then takes a weight measurement at block 1158. In one embodiment, processor may be programmed to wait to take the weight measurement for t seconds in order for the activity sensed by vibration sensor 920 in block 1154 to finish and to get an accurate weight reading. At block 1160, it is determined whether the measured weight is less than the previous measured weight. If the measured weight is not less than the previous measured weight, the method passes to block 1162 where it is further determined whether the previous event was a “ROLL REMOVAL” event. If the previous event was not a “ROLL REMOVAL” event, then the method passes back to block 1152 without incrementing the counters of any type of event. In this instance, the activity may be attributed to the user fiddling with or moving smart device 900, 1000. If, however, the previous event was a “ROLL REMOVAL” event, then the method passes to block 1164 and processor 921, 1021 increments the “NEW ROLL” event counter by, for example, a count of one. In this instance, the weight increase is attributed to a new roll of paper towel being inserted onto spindle 106, 206. After “NEW ROLL” event counter is incremented, the method passes back to block 1152 to conserve energy and wait for the next sensed activity.

With reference back to block 1160, if the measured weight is less than the previous measured weight, the method passes to block 1166 where it is further determined whether the difference between the measured weight and the previous measured weight is greater than a threshold amount. In other words, a determination is made of whether the newly measured smaller or lesser weight is by a lot or is by a little in comparison to the previously measured weight. If the difference is greater than the threshold amount, then the newly measured smaller or lesser weight is by a lot and the method passes to block 1168 where processor 921, 1021 increments the “ROLL REMOVAL” event counter by, for example, a count of one. If, however, the difference is less than the threshold amount, then the newly measured smaller or lesser weight is by a little and the method passes to block 1170 where processor 921, 1021 increments the “ROLL USAGE” event counter by, for example, a count of one. After either the “ROLL REMOVAL” or the “ROLL USAGE” event counter is incremented, the method passes back to block 1152 where processor 921, 1021 is powered down to conserve energy and wait for the next sense activity.

Under one embodiment, processor 921 and 1021 report consumption events to an auto replenishment service or system as shown in flowchart 300 of FIG. 6. In one embodiment and at block 1122, processor 921, 1021 broadcasts the current counts for each of the “NEW ROLL,” “ROLL REMOVAL” and “ROLL USAGE” event counters. At block 304, smart devices 900 and 1000 power down and at block 306 go into sleep mode for x seconds before passing back to block 302 to transmit consumption event information. For example, x seconds may be 30 seconds. In this way, smart devices 900 and 1000 keep periodically transmitting event count data without needing to know whether a receiver was in range to receive the transmitted data. Under one embodiment, a hand held device which has software installed related to the auto replenishment service or system, may receive the transmitted data any time that the handheld device is in range of smart devices 900 and 1000. The handheld device then updates the service or system with the new event information. In some embodiments, smart device 900 and 1000 may transmit more information than counts of “NEW ROLL,” “ROLL REMOVAL” and “ROLL USAGE” events including weight measurements and counts of sensed vibration activity in order to provide information to a prediction engine of the auto replenishment service or system that aids in refining the prediction engine with more accurate predictions of the user's use of paper towel rolls.

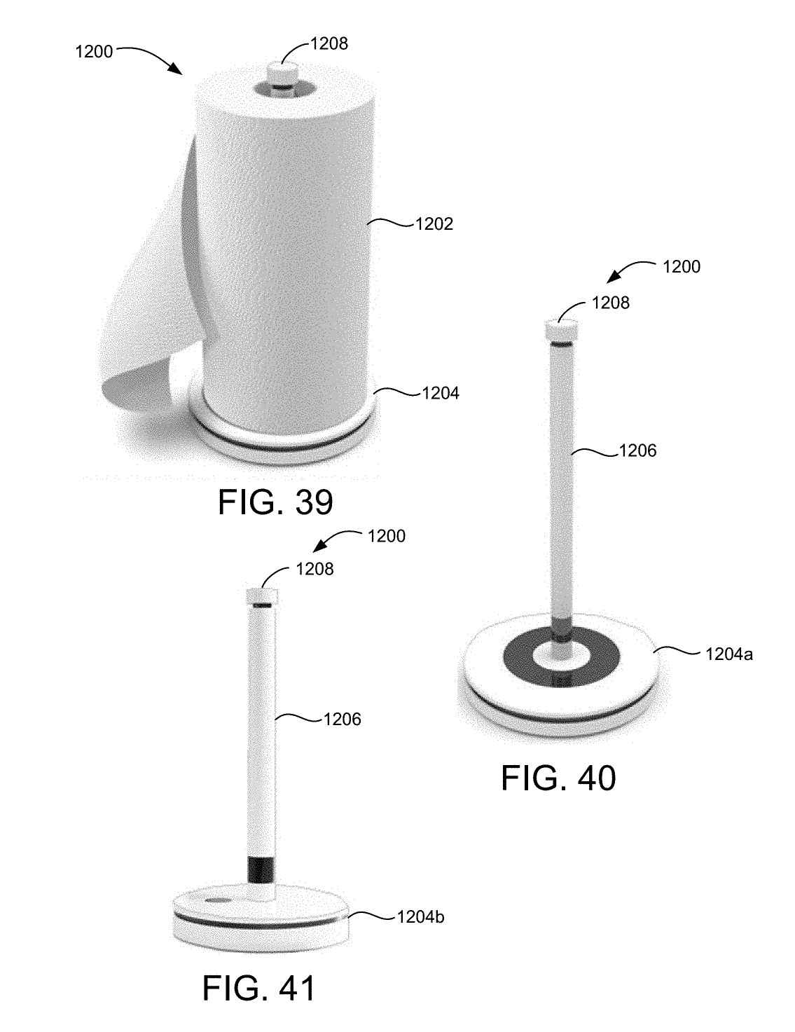

FIG. 39 is a top perspective view of a smart device 1200 for a household consumable 1202 according to an embodiment. FIG. 40 is a top perspective view of smart device 1200 of FIG. 39 without household consumable 1202 and having base 1204a. FIG. 41 is a perspective view of smart device 1200 of FIG. 39 with an alternative base 1204b. In particular, smart device 1200 is a smart paper towel holder where household consumable 1202 is a roll of paper towels. Smart device 1200 includes either a base 1204a or 1204b, a spindle 1206 and a top cap 1208, where base 1204a or 1204b connects to a bottom of spindle 1206. The components that enable device 1200 to sense activity, connect with a network and report consumption events and therefore be part of the IoT are housed within base 1204a or 1204b and spindle 1206.

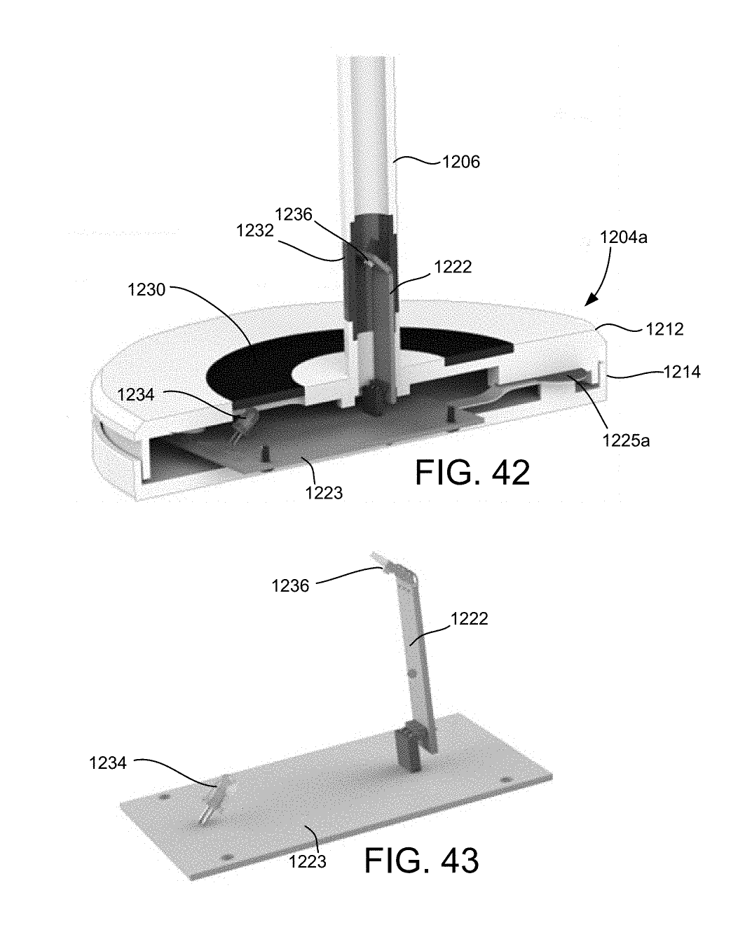

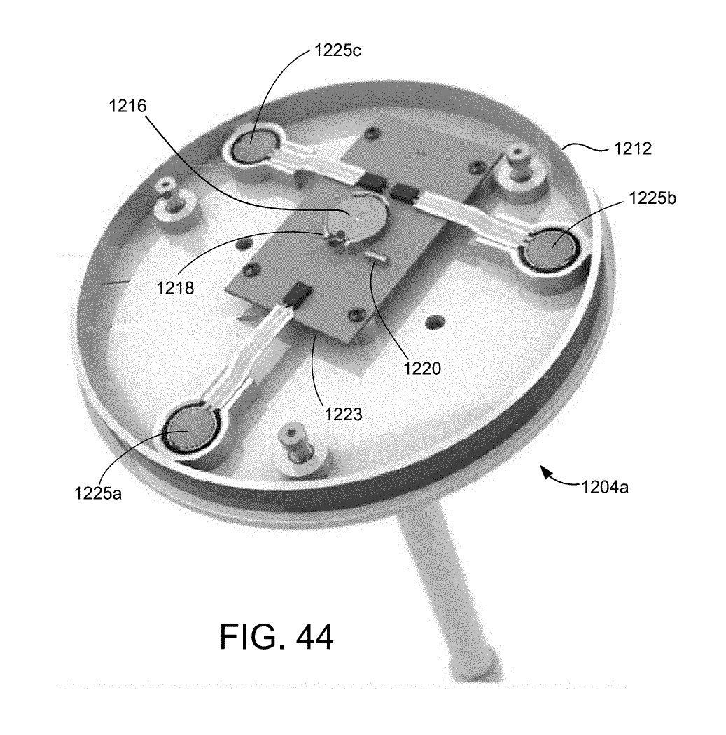

FIG. 42 is a perspective section view of smart device 1200 having base 1204a, FIG. 43 is a perspective view of PCBAs used in smart device 1200 and FIG. 44 is a bottom perspective view of smart device 1200 having base 1204a and with lower housing 1214 of base 1204 removed. As illustrated in FIGS. 42 and 44, base 1204a includes an upper housing 1212, a lower housing 1214 and a lower filter lens 1230 (not shown in FIG. 44). Spindle 1206 is connected to upper housing 1212 of base 1204a and includes an upper filter lens 1232.

Housed between upper housing 1212 and lower housing 1214 and within the bottom portion of spindle 1206 are a plurality of internal components including a detector printed circuit board assembly (PCBA) 1222, a main printed circuit board assembly (PCBA) 1223, a battery 1216 that is mounted into a battery housing 1218, a vibration sensor 1220 mounted to a main PCBA 1223, a processor that is integrated with main PCBA 1223, a plurality of force-sensing resistors (FSRs) 1225a, 1225b and 1225c (in this embodiment three FSRs), an IR (infrared) emitter 1234 and a IR receiver 1236.

Besides smart device 200 being capable of sensing and taking weight measurements using FSRs 1225a, 1225b and 1225c, smart device 1200 is also capable of sensing activity or motion of smart device 1200 with vibration sensor 1220 and sensing presence of a paper towel roll on spindle 1206 using IR emitter 1234 and IR receiver 1236. When vibration sensor 1220 (mounted to main PCBA 1223) senses motion or activity, the processor on main PCBA 1223 powers up, reads the presence sensor and takes a weight measurement from FSRs 1225a, 1225b and 1225c. In particular, IR emitter 1234 may be an IR LED emitter that may be on and emitting infrared light. At least a portion of the infrared light being emitted from IR emitter 1234 travels through lower filter lens 1232. If a paper towel roll is not present on spindle 1206, then the IR light travels through upper filter lens 1232 and is received by IR receiver 1236. If a paper towel roll is present on spindle 1206, then the paper towel roll blocks IR light from reaching IR receiver 1236.

Together, sensed activity or motion, sensed presence and sensed weight aid in determining three types of consumption events determined by smart device 1200 including a “NEW ROLL” consumption event, a “ROLL REMOVAL” consumption event and a “ROLL USAGE” consumption event. For purposes of simplifying the data derived and reported by smart device 1200 as well as making communication with an auto replenishment service or system efficient, smart device 1200 keeps a running total of counts in the form of counters for each of these three types of consumption events to report to an auto replenishment service or system. The service or system takes these reports and feeds them to a prediction engine to determine when the user needs replenishment of the consumable. In this embodiment and as previously mentioned, the consumables are rolls of paper towels.

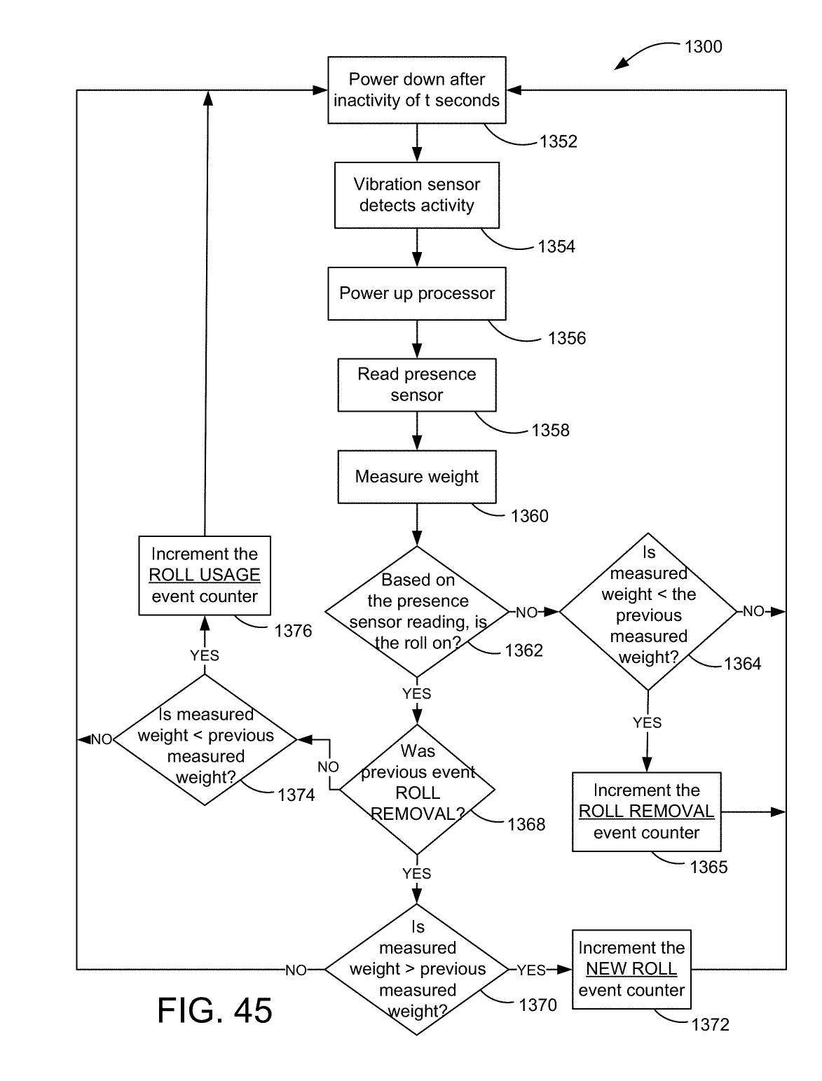

FIG. 45 is a flow chart 1300 of a method of tracking consumption events of a consumable loaded on smart device 1200 according to an embodiment. At block 1352, the processor powers down after t seconds of inactivity. In one example, t seconds may be 30 seconds, however, any amount of time is possible as long as after a set amount of time the processor is triggered to go into sleep mode. In sleep mode, the processor draws less power and conserves battery life. At block 1354, vibration sensor 1220 detects or senses activity or motion resulting in the processor being powered up at block 1356. The processor then senses presence of a paper towel roll on spindle 1206 at block 1358 and takes a weight measurement at block 1360. In one embodiment, the processor may be programmed to wait for a set amount of time to take the presence reading and weight measurement in order for the activity to finish and to get an accurate value.

At block 1362 and based on the presence sensor reading, it is determined whether the paper towel roll is on spindle 1206 or not. If the paper towel roll is not on spindle 1206, then the method passes to block 1364 and further determines if the measured weight is less than the previous measured weight. If the measured weight is not less than the previous measured weight, the method passes directly back to 1352 without incrementing any counters. In this instance, the activity may be attributed to the user fiddling with or moving smart device 500 while the spindle was empty. If, however, the measured weight is less than the previous measured weight, then the method passes to block 1365 and increments the “ROLL REMOVAL” event counter by, for example, a count of one before passing directly back to block 1352 for powering down. In this instance, the weight decrease in combination with a roll not being present on spindle 1206 is attributed to a roll having been removed from spindle 1206.

With reference back to block 1362, if the paper towel roll is on spindle 1206, then the method passes to block 1368 where it is further determined whether the previous event was a “ROLL REMOVAL” event. If the previous event was a “ROLL REMOVAL” event, then the method passes to block 1370 where it is further determined whether the measured weight is greater than the previous measured weight. If the measured weight is greater than the previous measured weight, then the method passes to block 1372, increments the “NEW ROLL” event counter by, for example, a count of one and then passes directly back to block 1352 to power down. In this instance, the combination of a roll being on spindle 1206, the previous event being a roll removal from spindle 1206 and the weight increase is attributed to a new roll having been placed on spindle 1206. If at block 1370 the measured weight is less than the previously measured weight, then the method passes directly back to block 1352 to power down. In this instance, the activity may be attributed to the user fiddling with or moving smart device 500 while the spindle is holding a paper towel roll.

If at block 1368, the previous event was not a “ROLL REMOVAL” event, then the method passes to block 1374 where it is further determined whether the measured weight is less than the previously measured weight. If the measured weight is less than the previously measured weight, then the method passes to block 1376, increments the “ROLL USAGE” event counter by, for example, a count of one and then passes directly back to block 1352 to power down. In this instance, the combination of a roll being on spindle 1206, the previous event not being a roll removal from spindle 1206 and the weight decrease is attributed to a portion of the paper towel roll being used. If at block 1374 the measured weight is not less than the previous measured weight, then the method passes directly to block 1352 to power down. In this instance, the activity may be attributed to the user fiddling with or moving smart device 500 while the spindle is holding a paper towel roll.

Under one embodiment, the processor of FIGS. 39-45 reports consumption events to an auto replenishment service or system as show in flow chart 300 of FIG. 6. In one embodiment, smart device 1200 communicates and reports consumption event information to an auto replenishment service or system using Bluetooth®. In still another embodiment, smart device 1200 communicates and reports consumption event information to the auto replenishment service or system using Bluetooth® Low Energy (BLE). In addition and under one embodiment, smart device 1200 transmits consumption event information periodically.

As illustrated in FIG. 6, at block 302, the processor of smart device 1200 broadcasts the current counts for each of the “NEW ROLL,” “ROLL REMOVAL” and “ROLL USAGE” event counters. At block 304, smart device 1200 powers down and at block 306 goes into sleep mode for t seconds before passing back to block 302 to transmit consumption event information. For example, x seconds may be 30 seconds. In this way, smart device 1200 keeps periodically transmitting event count data without needing to know whether a receiver was in range to receive the transmitted data. Under one embodiment, a hand held device which has software installed related to the auto replenishment service or system, may receive the transmitted data any time that the handheld device is in range of smart device 1200. The handheld device then updates the service or system with the new event information. In some embodiments, smart device 1200 may transmit more information than counts of “NEW ROLL,” “ROLL REMOVAL” and “ROLL USAGE” events including presence sensor readings, weight measurements and counts of sensed vibration activity in order to provide information to a prediction engine of the auto replenishment service or system that aids in refining the prediction engine with more accurate predictions of the user's use of paper towel rolls.

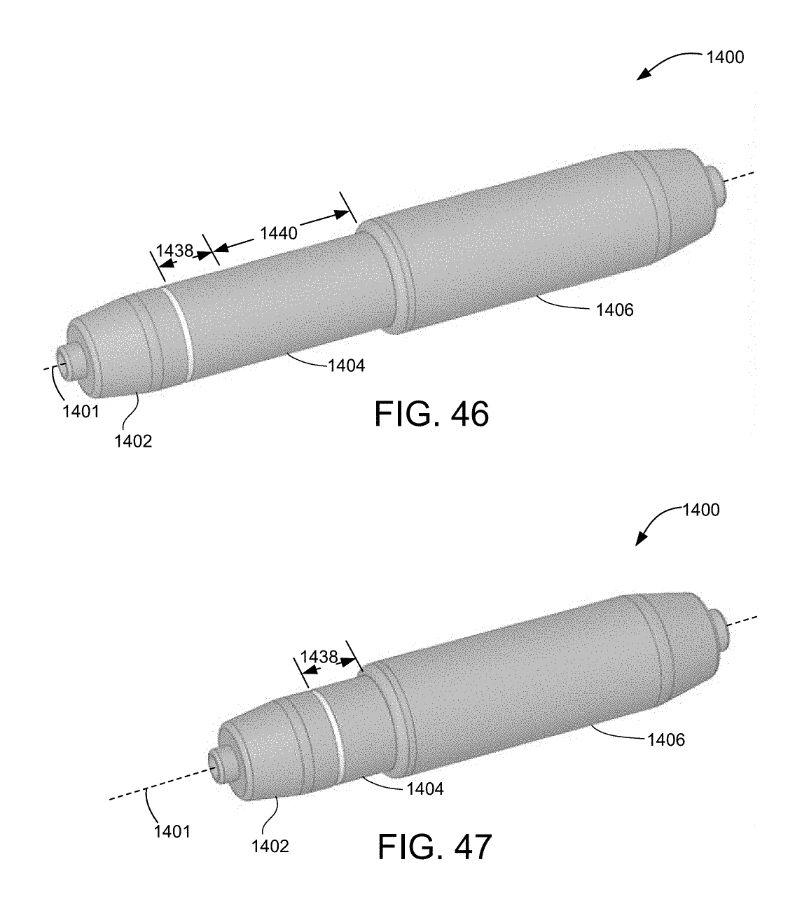

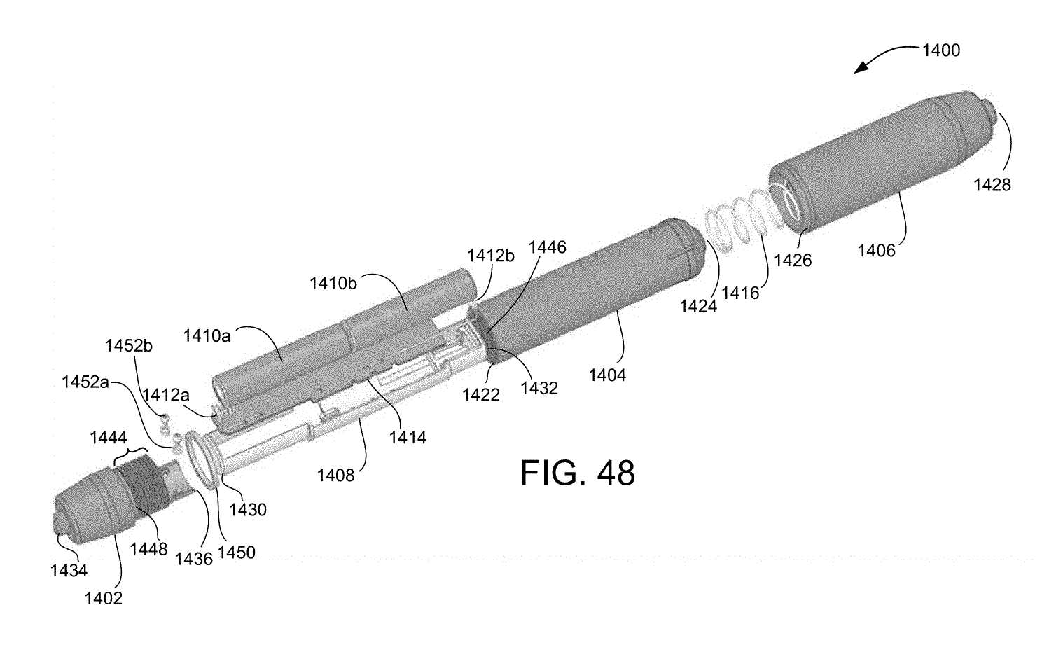

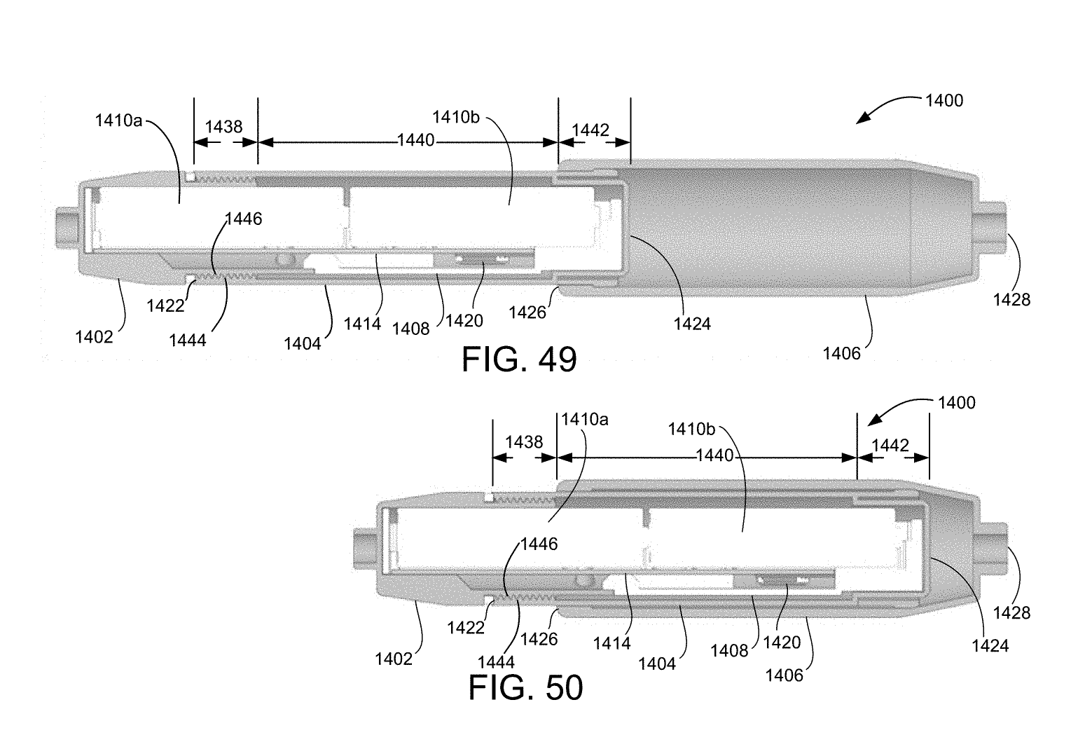

FIG. 46 is a perspective view of a smart device 1400 configured in a first position that dispenses a household consumable according to an embodiment, and FIG. 47 is a perspective view of smart device 1400 configured in a second position according to an embodiment. FIG. 48 is an exploded perspective view of smart device 1400, FIG. 49 is a section view of smart device 1400 configured in the first position and FIG. 50 is a section view of smart device 1400 configured in the second position. In particular, smart device 1400 is a smart toilet paper spindle or roller and the household consumable being dispensed is a roll of toilet paper. Like most toilet paper holders, the spindle is compressed along a Z-axis 1401 into a holder when configured in the first position and decompressed along a Z-axis 1401 and removed from the holder when configured in the second position.

Smart device 1400 includes a cap 1402, an inner tube 1404, an outer tube 1406, an inner carrier 1408 and a plurality of internal components. Inner carrier 1408 is located entirely inside inner tube 1404 and inside at least a portion of outer tube 1406. The internal components housed inside inner carrier 1408 are a pair of a batteries 1410a and 1410b, a pair of battery contacts 1412a and 1412b and a printed circuit board assembly (PCBA) 1414. Housed inside outer tube 1406 is a compression spring 1416. Mounted to PCBA 1414 is a sensor 1418 (shown diagrammatically in FIG. 58), such as a 3-axis (X-Y-Z) accelerometer, and a processor 1420. In general, a 3-axis accelerometer reports acceleration vectors, each including an X, Y and Z direction plus a magnitude.

As illustrated in FIGS. 46-50, inner tube 1404 includes a first end 1422 and a second end 1424. Outer tube 1406 includes a first end 1426 and a second end 1428. As illustrated in FIG. 48, inner carrier 1408 includes a first end 1430 and a second end 1432. Cap 1402 includes a first end 1434 and a second end 1436. As illustrated in FIGS. 46-47 and 49-50, inner tube 1404 is slidably located along Z-axis 1401 within and secured inside outer tube 1406 so that first end 1422 of inner tube 1404 protrudes through an open first end 1426 of outer tube 1406. Inner carrier 1408, which houses PCBA 1414, is located entirely inside inner tube 1404. Portions of inner carrier 1408 are placed inside at least a portion of outer tube 1406 since portions of inner tube 1404 are located inside outer tube 1406.

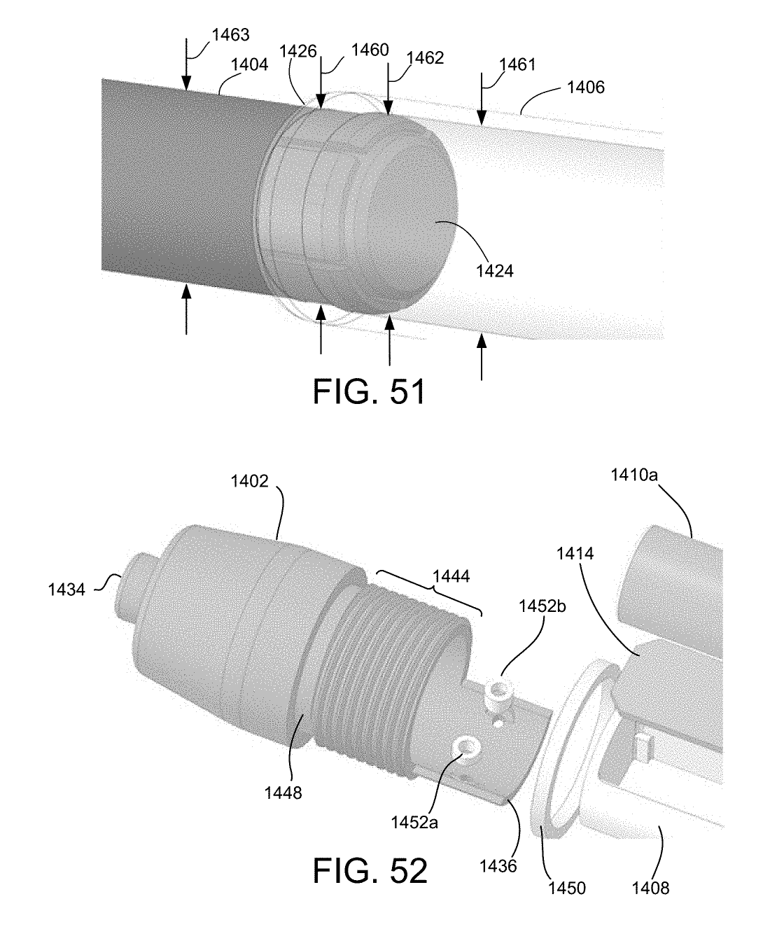

FIG. 51 is an enlarged perspective view of the portion of smart device 1400 where inner tube 1404 is coupled to outer tube 1406. In FIG. 51, inner tube 1404 is shown in solid while outer tube 1406 is shown in phantom for ease of illustration. As illustrated in FIGS. 49-51, outer tube 1406 includes a first inner diameter 1460 at first end 1426 and a second inner diameter 1461 that extends for a length along the inside outer tube 1406. Second inner diameter 1461 is greater than first inner diameter 1460. Inner tube 1404 includes a first outer diameter 1462 at a second end 1424 and a second outer diameter 1463 that extends for a length along the outside of inner tube 1404. First inner diameter 1462 is greater than second inner diameter 1463. First inner diameter 1460 of outer tube 1406 accommodates second outer diameter 1463 of inner tube 1404 and second inner diameter 1461 of outer tube 1406 accommodates first outer diameter 1462 of inner tube 1404. As illustrated, outer tube 1406 allows inner tube 1404 to slide within outer tube 1406, but disallows inner tube 1404 from being removed from outer tube 1406 at first end 1426.

As illustrated in FIGS. 47 and 50, when smart device 1400 is fully compressed in the second position along Z-axis 1401, first end section 1438 of inner tube 1404 protrudes through first end 1426 of outer tube 1406, while middle section 1440 and second end section 1442 of inner tube 1404 are fully surrounded by outer tube 1406. As illustrated in FIGS. 46 and 49, when smart device 100 is fully decompressed along Z-axis 1401 in the first position or in other words when smart device 100 is fully unloaded from a holder, first end section 1438 of inner tube 1404 and middle section 1440 of inner tube 1404 protrude through first end 1426 of outer tube 1406 and second end section 1442 of inner tube 1404 is fully surrounded by outer tube 1406.

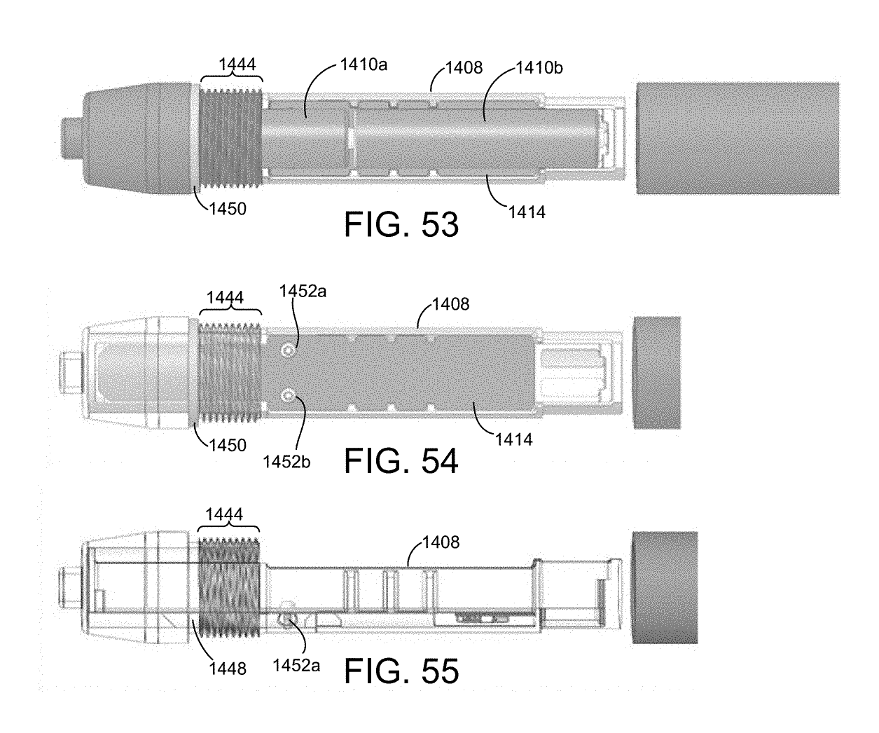

FIG. 52 is an enlarged view of a portion of the exploded perspective view of FIG. 48. FIG. 53 is an enlarged exploded top view of a portion of smart device 1400, FIG. 54 is an enlarged exploded bottom view of a portion of smart device 1400 where some components are shown in phantom and FIG. 55 is an enlarged exploded side view of a portion of smart device 1400 where some components are shown in phantom.

In one embodiment, while outer tube 1406 and inner tube 1404 are fixedly assembled together as discussed above, other portions of smart device 1400 are removably assembled together, for example, to allow the user to replace batteries. Cap 1402 includes external threads 1444 located on a portion of the external surface of cap 1402. Inner tube 1404 includes internal threads 1446 located on a portion of the internal surface of inner tube 1404. External threads 1444 of cap 1402 mate with or engage with internal threads 1446 of inner tube 1404. Cap 1402 further includes a groove 1448 that is located between first end 1434 of cap 1402 and external threads 1444. Within groove 1448 sits a gasket or O-ring 1450 that seals the internal components housed in inner tube 1404 from the external environment of smart device 1400. Therefore, gasket 1450 sits in groove 1448 of cap 1402 and snuggly fits against first end 1422 of inner tube 1404.

Not only is cap 1402 coupled to inner tube 1404, but cap 1402 is also coupled to inner carrier 1408 by, for example, a pair of fasteners 1452a and 1452b. In particular, the pair of fasteners 1452a and 1452b extend through PCBA 1414, inner carrier 1408 and connect to recesses in cap 1402. In this way, fasteners 1452a and 1452b secure cap 1402, PCBA 1414, batteries 1410a and 1410b and inner carrier 1408 altogether.

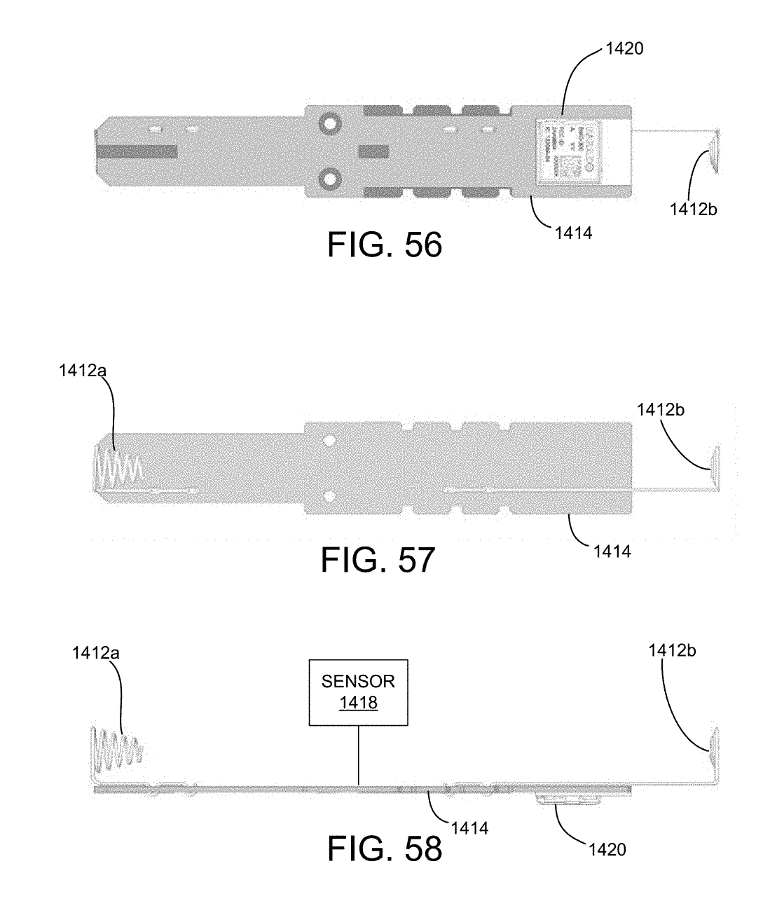

FIG. 56 is a bottom view of PCBA 1414 of smart device 1400 illustrated in FIGS. 46-50, FIG. 57 is a top view of FIG. 56 and FIG. 58 is a side view of FIG. 56. Using sensor 1418, smart device 1400 is capable of sensing activity or motion of smart device 1400. Sensed activity or motion by sensor 1418 aids in determining consumption events including a “NEW ROLL” consumption event and a “ROLL USAGE” consumption event. For purposes of simplifying the data derived and reported by smart device 1400 as well as making communication with an auto replenishment service or system efficient, the processor keeps a running total of counts in the form of counters for each type of consumption event to report to an auto replenishment service or system. The service or system takes these reports and feeds them to a prediction engine to determine when the user needs replenishment of the consumable. For example, processor 1420 uses sensor 1418 to interpret brief activations of device 1400 as usage events and longer-period activations as removal events. In this embodiment, the consumables are rolls of toilet paper, but could also be other types of consumables including paper towel rolls.

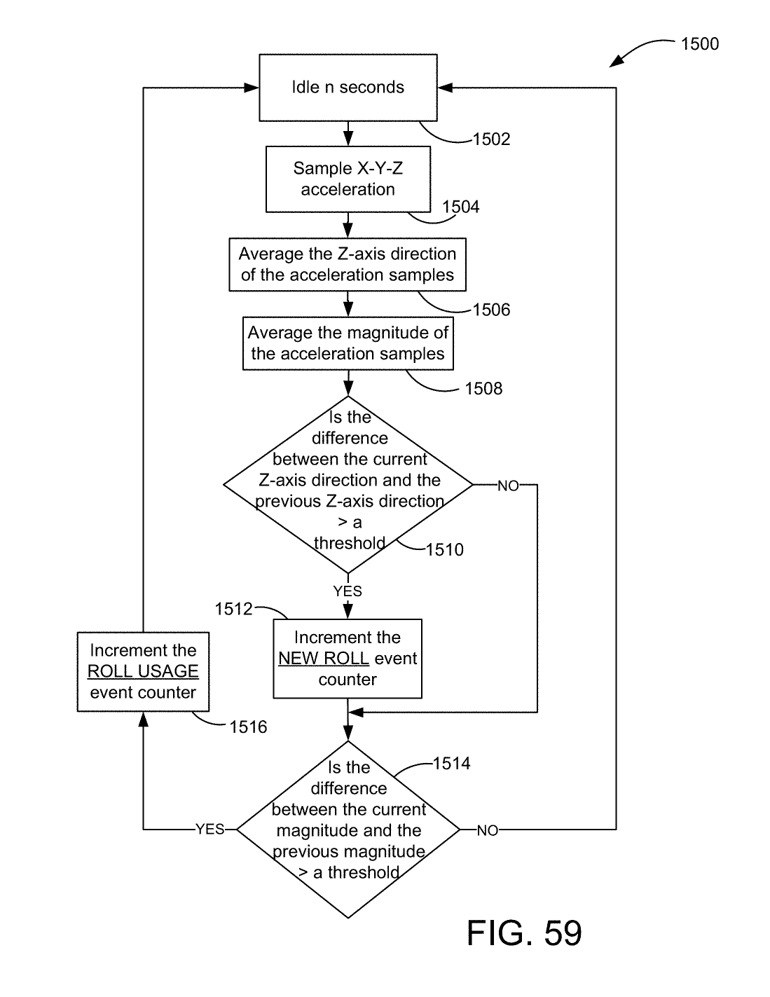

FIG. 59 is a flow chart 1500 of a method of tracking consumption of a consumable loaded on smart device 1400 according to an embodiment. At block 1502 and upon a user installing smart device 1400 with a roll of toilet paper and inserting smart device 1400 into a holder in the second (compressed) position, processor 1420 remains idle for n seconds. In one embodiment, n seconds may be 20 milliseconds (ms), however, any amount of time is possible as long as processor 1420 is under low power for an interval of n seconds. Under low power, processor 1420 draws less power and conserves battery life. After n seconds, the method passes to block 1504 and processor 1420 samples or polls sensor 1418 for acceleration vector values. At block 1506, the Z-axis direction of the acceleration vector values are averaged over q seconds, and at block 1508, values of the magnitude of the acceleration vector samples are averaged over p seconds. For example and under one embodiment, p may be equal to 1 second and q may be equal to 5 seconds. It should be realized that the average values of the Z-axis direction and the magnitude are absolute values.

At block 1510, it is determined whether the difference between the average value of the current Z-axis direction and the average value of the previous Z-axis direction is greater than a threshold. When the difference is greater than the threshold, processor 1420 passes to block 1512, increments the “NEW ROLL” event counter by, for example, a count of one, and then passes to block 1514. In this instance, the change in Z-axis direction is attributed to the dispenser being moved from the compressed second position illustrated in FIG. 47, which is the position smart device 1400 is in when located in a holder, to the decompressed first position illustrated in FIG. 46, which is the position smart device 1400 is in when removed from the holder. The “NEW ROLL” event counter may not be incremented again for s minutes. For example and under one embodiment, s may be equal to 2 minutes. This length of time allows for a roll to be replaced and smart device 1400 to be located back in the holder, however, other amounts of time are possible as long as enough time is given for smart device 1400 to be relocated into its holder. When the difference is not greater than the threshold, processor 1420 passes directly to block 1514 without incrementing the “NEW ROLL” event counter at block 1512. In this instance, the lack in change in Z-axis direction is attributed to smart device 1400 being stable and not being removed from its holder or decompressed from the second position to the first position.

At block 1514, it is determined whether the difference between the average value of the current magnitude of the acceleration vector samples and the previous magnitude of acceleration vector samples is greater than a threshold. When the difference is greater than the threshold, processor 1420 passes to block 1516, increments the “ROLL USAGE” event counter by, for example, one, and then passes back to block 1502 to return processor 1420 to an idle state. In this instance, the change in magnitude of the acceleration vector is attributed to the dispenser rotating or dispensing. Under one embodiment, the “ROLL USAGE” event counter may not be incremented again for r seconds. For example, r may be equal to 2 seconds, however, other amounts of time are possible. When the difference is not greater than the threshold, processor 1420 passes directly back to block 1502 without incrementing the “ROLL USAGE” event counter at block 1516. In this instance, the lack in change of magnitude of acceleration vector samples is attributed to smart device 1400 being stable and not being rotated for dispensing.

Under one embodiment, processor 1420 reports consumption events to an auto replenishment service or system as shown in flow chart 300 of FIG. 6. In one embodiment and at block 302, processor 1420 of smart device 1400 broadcasts consumption event information to an auto replenishment service or system using Bluetooth®. In particular and under one embodiment, processor 1420 broadcasts an advertising packet 3 times on each of a plurality of Bluetooth® channels including Bluetooth® Low Energy (BLE) channels. An advertising packet includes the current counts for each of the “NEW ROLL” and “ROLL USAGE” event counters. In addition and under one embodiment, smart device 1400 may transmit other consumption event information including sensor readings and counts of sensed activity in order to provide information to a prediction engine of the auto replenishment service or system that aids in refining the prediction engine with more accurate predictions of the user use of toilet paper rolls.

At block 304, processor 1420 powers down and at block 306 goes into a low power mode for x seconds, such as 30 seconds, before passing back to block 302 to again broadcast consumption event information. In this way, smart device 1400 keeps periodically transmitting event count data without needing to know whether a receiver was in range to receive the transmitted data. Under one embodiment, a hand held device which has software installed related to the auto replenishment service or system, may receive the transmitted data any time that the handheld device is in range of smart device 1400. The handheld device then updates the service or system with the new event information.

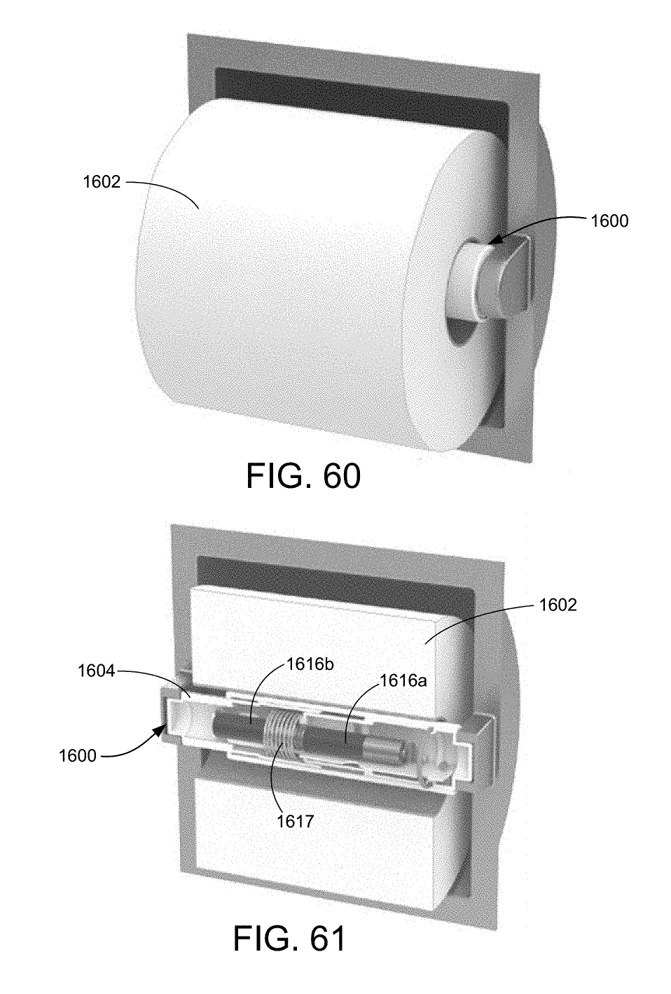

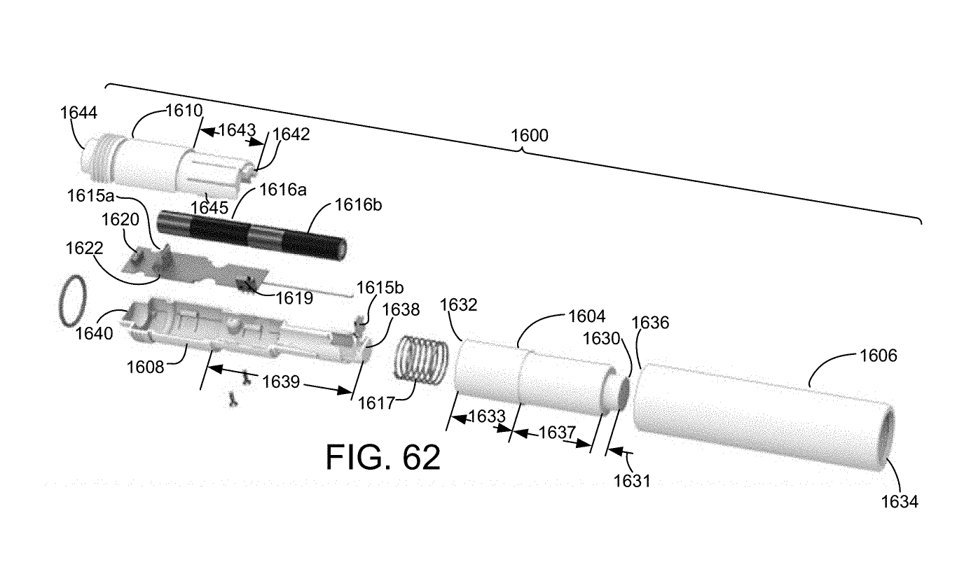

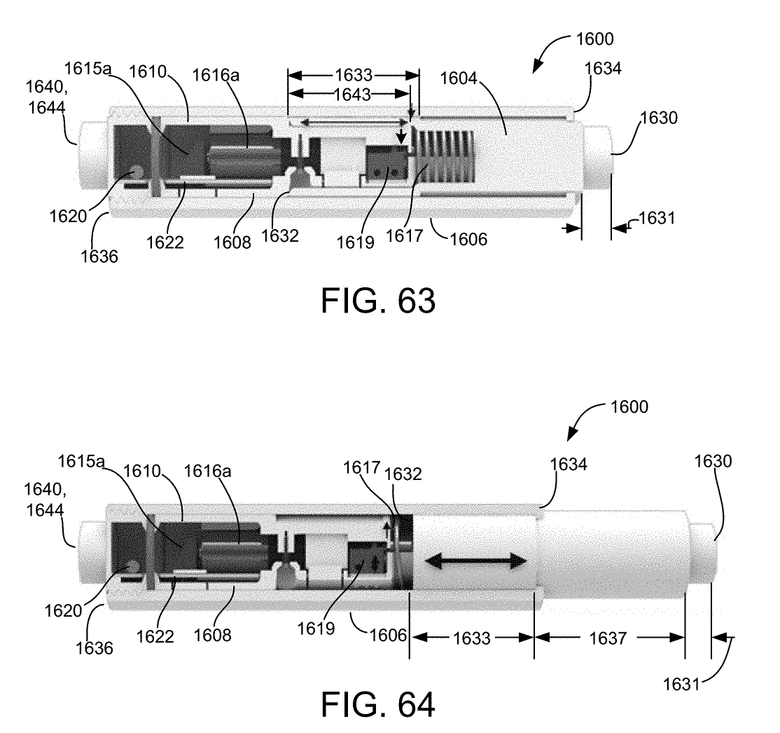

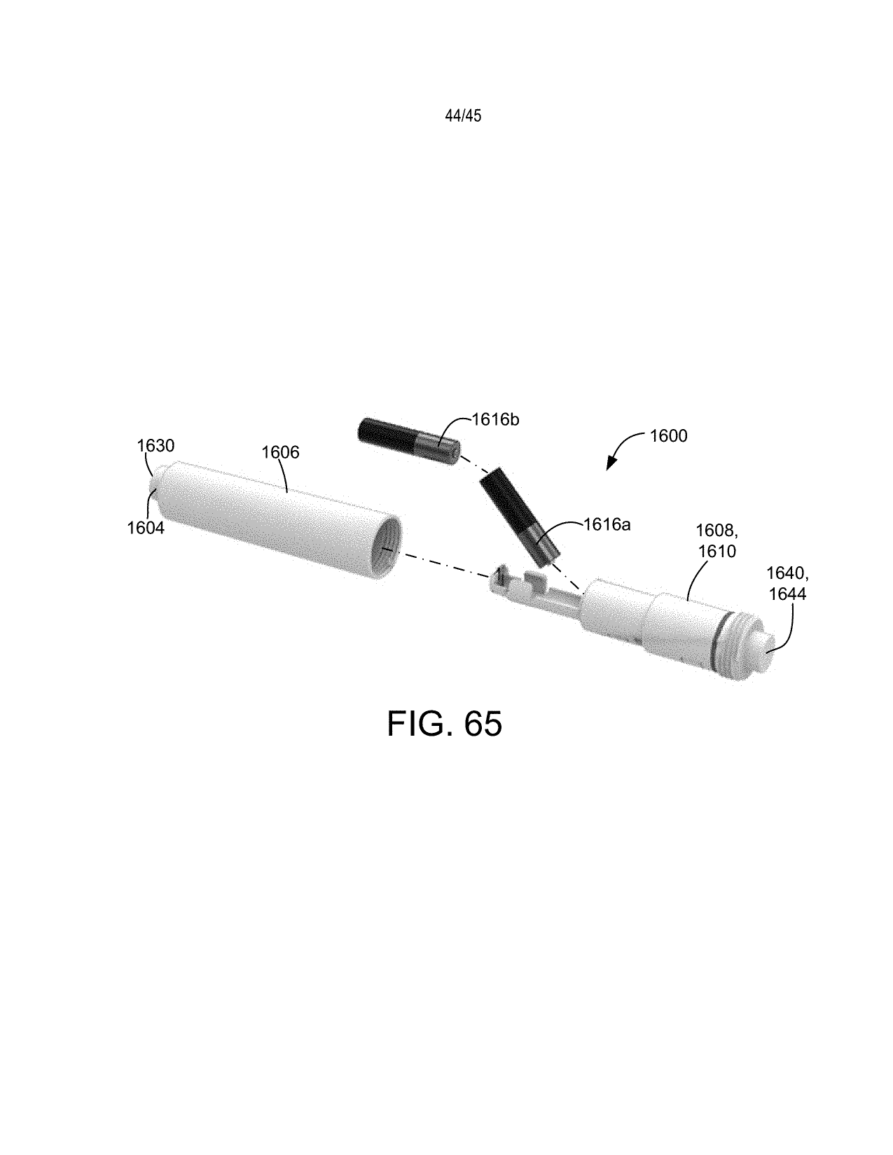

FIG. 60 is a perspective view of a smart device 1600 for a household consumable 1602 where smart device 1600 is holding household consumable 1602. FIG. 61 is a perspective sectional view of smart device 1600 and household consumable 1602. In particular, smart device 1600 is a smart toilet paper holder and household consumable 1602 is a roll of toilet paper. Smart device 1600 is the spindle or roller only of a toilet paper holder. FIG. 62 is an exploded perspective view of smart device 1600, FIG. 63 is a sectional view of smart device 1600 in a compressed configuration, FIG. 64 is a partial sectional view of smart device 1600 in a decompressed configuration and FIG. 65 is another exploded perspective view of smart device 1600.

Smart device 1600 includes an inner tube 1604, an outer tube 1606, an inner carrier 1608, an inner carrier cover 1610 and a plurality of internal components. Inner carrier 1608 and inner carrier cover 1610 are coupled together either integrally or non-integrally and are located inside outer tube 1606 and inside at least a portion of inner tube 1608. Housed inside inner carrier 1608 and inner carrier cover 1610 are a pair of a batteries 1616a and 1616b, a pair of battery contacts 1615a and 1615b and a printed circuit board assembly (PCBA) 1622. Housed inside inner tube 1604 is a compression spring 1617. Mounted to PCBA 1622 is a vibration sensor 1620, a processor (not shown), a limit switch 1619 and battery contact 1615a. Battery contact 1615b is mounted to an end of inner carrier 1608.

As illustrated in FIGS. 62-64, inner tube 1604 includes a first end 1630 and a second end 1632. Outer tube 1606 includes a first end 1634 and a second end 1636. As illustrated in FIG. 62, inner carrier 1608 includes a first end 1638 and a second end 1640. Inner carrier cover 1610 includes a first end 1642 and a second end 1644. As illustrated in FIGS. 63 and 64, inner tube 1604 is located within outer tube 1606 so that first end 1630 of inner tube 1604 protrudes through an open first end 1634 of outer tube 1606. Inner carrier 1608 and inner carrier cover 1610, which are coupled together and house PCBA 1622, are located inside outer tube 1606 so that second ends 1640 and 1644 of inner carrier 1608 and inner carrier cover 1610, respectively, protrude through open second end 1636 of outer tube 1606. In addition, portions of inner carrier 1608 and inner carrier cover 1610 are placed inside at least a portion of inner tube 1604.

As illustrated in FIG. 63, when smart device 1600 is fully compressed, only first end section 1631 of inner tube 1604 protrudes through first end 1634 of outer tube 1606 and second end section 1633 of inner tube 1604 fully surrounds a first end section 1639 (see FIG. 62) of inner carrier 1608 and a first end section 1643 of inner carrier cover 1610. As illustrated in FIG. 64, when smart device 1600 is fully decompressed or in other words when smart device 1600 is fully unloaded from its holder, first end section 1631 of inner tube 1604 and a middle section 1637 of inner tube 1604 protrude through first end 1634 of outer tube 1606 and second end section 1633 of inner tube 1604 fully surrounds only a portion of first end section 1639 of inner carrier 1608.

Besides smart device 1600 being capable of sensing when smart device 1600 is compressed using limit switch 1619, smart device 1600 is also capable of sensing activity or motion of smart device 1600 with vibration sensor 1620. When vibration sensor 1620 (mounted to PCBA 1622) senses motion or activity, the processor of PCBA 1622 powers up and determines whether limit switch 1619 is under load (e.g., smart device 1600 is in some level of a compressed configuration) or limit switch 1619 is unloaded from its holder (e.g., smart device 1600 is in a fully decompressed configuration). As illustrated in FIG. 63, limit switch 1619 is under load and therefore in a compressed configuration when second end section 1633 of inner tube 1604 surrounds any portion of first end section 1643 of inner carrier cover 1610. When second end section 1633 of inner tube 1604 surrounds any portion of first end section 1643 of inner carrier cover 1610, then second end section 1633 of inner tube 1604 pushes down on first end section 1643 of inner carrier cover 1610. First end section 1643 of inner carrier cover 1610 includes at least one clip 1645 positioned on the interior of first end section 1643. Clip 1645 pushes on limit switch 1619, which indicates to the processor that smart device 1600 is in a compressed configuration.

Together, sensed activity or motion by vibration sensor 1620 and an activated limit switch 1619 aid in determining three types of consumption events determined by smart device 1600 including a “NEW ROLL” consumption event, a “ROLL REMOVAL” consumption event and a “ROLL USAGE” consumption event. For purposes of simplifying the data derived and reported by smart device 1600 as well as making communication with an auto replenishment service or system efficient, the processor keeps a running total of counts in the form of counters for each of these three types of consumption events to report to an auto replenishment service or system. The service or system takes these reports and feeds them to a prediction engine to determine when the user needs replenishment of the consumable. In this embodiment, the consumables are rolls of toilet paper, but could also be other types of consumable including paper towel rolls.

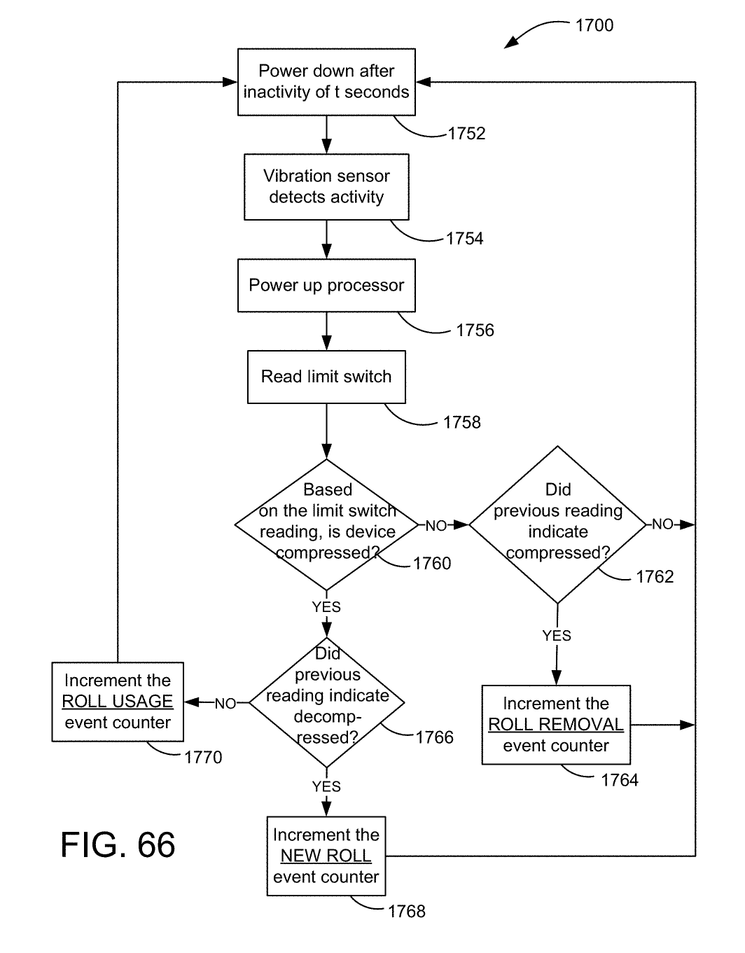

FIG. 66 is a flow chart 1700 of a method of tracking consumption events of a consumable loaded on smart device 1600 according to an embodiment. At block 1752, the processor powers down after t seconds of inactivity. In one example, t seconds may be 30 seconds, however, any amount of time is possible as long as after a set amount of time the processor is triggered to go into sleep mode. In sleep mode, the processor draws less power and conserves battery life. At block 1754, vibration sensor 1720 detects or senses activity or motion resulting in the processor being powered up at block 1756. The processor takes a reading of limit switch 1619 at block 1758. In one embodiment, the processor may be programmed to wait to take the reading for t seconds in order for the activity to finish and to get an accurate value.

At block 1760 and based on the current reading of limit switch 1619, it is determined whether device 1600 is compressed or not. If device 1600 is not compressed, then the method passes to block 1762 to further determine if the previous reading of limit switch 1619 indicated that device 1600 was compressed. If the previous reading indicated that device 1600 was compressed, the method passes to block 1764 and increments the “ROLL REMOVAL” event counter by, for example, a count of one and passes back to block 1752 to power down. In this instance, the activity may be attributed to device 1600 being removed from its holder and therefore a roll of toilet paper being removed. If the previous reading indicated that device 1600 was not compressed, the method passes directly back to 1752 to power down without incrementing any counters. In this instance, the activity may be attributed to the user fiddling with or moving smart device 500 while device 1600 is removed from its holder.

With reference back to block 1760, if it is determined that device 1600 is compressed, then the method passes to block 1766 to further determine if the previous reading of limit switch 1619 indicated that device 1600 was decompressed. If the previous reading indicated that device 1600 was decompressed, the method passes to block 1768, increments the “NEW ROLL” event counter by, for example, a count of one and passes back to block 1752 to power down. In this instance, the activity may be attributed to device 1600 being put back into its holder and therefore back into its holder with a new roll of toilet paper. If the previous reading indicated that device 1600 was not decompressed, the method passes to block 1770, increments the “ROLL USAGE” event counter by, for example, a count of one and passes back to block 1752 to power down. In this instance, the activity may be attributed to device 1600 being used because the device 1600 was previously compressed and is still compressed.

Under one embodiment, the processor of FIGS. 60-66 reports consumption events to an auto replenishment service or system as shown in flow chart 300 of FIG. 6. In one embodiment, smart device 1600 communicates and reports consumption event information to an auto replenishment service or system using Bluetooth®. In still another embodiment, smart device 1600 communicates and reports consumption event information to the auto replenishment service or system using Bluetooth® Low Energy (BLE). In addition and under one embodiment, smart device 1600 transmits consumption event information periodically.

As illustrated in FIG. 6, at block 302, the processor in smart device 1600 broadcasts the current counts for each of the “NEW ROLL,” “ROLL REMOVAL” and “ROLL USAGE” event counters. At block 304, smart device 1600 powers down and at block 306 goes into sleep mode for x seconds, such as 30 seconds, before passing back to block 302 to transmit consumption event information. In this way, smart device 1600 keeps periodically transmitting event count data without needing to know whether a receiver was in range to receive the transmitted data. Under one embodiment, a hand held device which has software installed related to the auto replenishment service or system, may receive the transmitted data any time that the handheld device is in range of smart device 1600. The handheld device then updates the service or system with the new event information. In some embodiments, smart device 1600 may transmit more information than counts of “NEW ROLL,” “ROLL REMOVAL” and “ROLL USAGE” events including limit switch readings and counts of sensed vibration activity in order to provide information to a prediction engine of the auto replenishment service or system that aids in refining the prediction engine with more accurate predictions of the user use of toilet paper rolls.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A smart device for a household consumable comprising:
at least one load sensor configured to measure a current load of a household consumable being supported by the smart device; and
a processor configured to compare the current load to a previously measured load to determine whether to increment one of a plurality of consumption event counters;
wherein the processor is configured to periodically transmit data located in the plurality of consumption event counters.

2. The smart device of claim 1, wherein the plurality of consumption event counters comprise a counter indicative of the household consumable having been removed, a counter indicative of the household consumable having been refilled and a counter indicative of the household consumable having been used.

3. The smart device of claim 1, wherein the plurality of consumption event counters comprise a counter indicative of the household consumable having been refilled and a counter indicative of the household consumable having been used.

4. The smart device of claim 1, wherein the processor is further configured to compare the difference between the current load and the previously measured load against a threshold to determine whether to increment one of the plurality of consumption event counters.

5. The smart device of claim 1, wherein the processor is configured to idle for a set amount of time between weight measurements.

6. The smart device of claim 1, wherein the household consumable comprises a paper towel roll.

7. The smart device of claim 6, wherein the processor is configured to increment a new roll event counter when the current load is greater than the previously measured load and a difference between the current load and the previously measured load is greater than a threshold.

8. The smart device of claim 6, wherein the processor is configured to increment a roll removal event counter when the current load is less than the previously measured load and a difference between the current load and the previously load is greater than a threshold.

9. The smart device of claim 6, wherein the processor is configured to increment a usage event counter when the current load is less than the previously measured load and a difference between the current load and the previously measured load is less than a threshold.

10. The smart device of claim 1, wherein the household consumable comprises liquid soap.

11. The smart device of claim 10, wherein the processor is configured to increment a refilled event counter when the current load is greater than the previously measured load and a difference between the current load and the previously measured load is greater than a threshold.

12. The smart device of claim 10, wherein the processor is configured to increment a usage event counter when the current load is less than the previously measured load.

13. A smart device for a household consumable comprising:
a spindle configured for insertion into a holder and configured to support a roll of household consumable;
an accelerometer located in the spindle and configured to report current acceleration vectors including a Z-axis direction and a magnitude;
a processor configured to:
compare the Z-axis direction with a previous Z-axis to determine whether to increment one of a plurality of consumption event counters; and
compare the magnitude with a previous magnitude to determine whether to increment a different one of the plurality of consumption event counters; and
wherein the processor periodically transmits data located in the plurality of consumption event counters.

14. The smart device of claim 13, wherein the plurality of consumption event counters include a counter indicative of a new roll having been inserted on the spindle and a counter indicative of the roll that is being supported by the spindle having been used.

15. The smart device of claim 13, wherein the processor is further configured to power up from a low power mode to sense acceleration at set intervals of time.

16. The smart device of claim 13, wherein the housing comprises an outer tube, an inner tube located at least partially within the outer tube and an inner carrier located within the inner tube, wherein the inner tube is loaded within the outer tube and against a compression spring located inside the outer tube and is configured into one of a first position and a second position.

17. The smart device of claim 16, wherein when the inner tube is configured into the first position, an end of the inner tube acts to compress the compression spring and a greater length of the inner tube is located within the outer tube than outside of the outer tube.

18. The smart device of claim 16, wherein when the inner tube is configured into the second position, an end of the inner tube applies no force on the compression spring and less of a length of the inner tube is located within the outer tube than outside of the outer tube.

19. A smart device for dispensing a household consumable comprising:
a base that houses a plurality of internal components including at least one load sensor, a processor and a platform, wherein the at least one load sensor is coupled to the platform;
a body coupled to the base and including an internal bag made of a flexible material, wherein the internal bag holds a liquid; and
a pump configure to pump liquid out of the internal bag and through a spout connected to the pump;
wherein the internal bag engages with the platform and is weighed by the at least one load sensor; and
wherein the processor is configured to compare a weight of the internal bag and its liquid contents to a previously measured weight of the internal bag and its liquid contents to determine if a consumption event has occurred.

20. The smart device of claim 19, wherein the internal bag comprises a main section and an accordion section, the main section preventing the liquid contents of the internal bag from migrating into the body of the smart device and the accordion section allowing the internal bag to stretch to rest on the platform.
